(19) United States
(12) Patent Application Publication
(10) Pub. No.: US 2018/0161772 A1
(43) Pub. Date: Jun. 14, 2018

(54) MICROFLUIDIC DEVICES AND METHODS OF USE THEREOF

(71) Applicant: POC MEDICAL SYSTEMS INC, LIVERMORE, CA (US)

(72) Inventors: AMRITHA RAMMOHAN, SANJOSE, CA (US); JAMES BERRY, LIVERMORE, CA (US); SANJEEV SAXENA, LIVERMORE, CA (US); ANDREA CUPPOLETTI, LIVERMORE, CA (US); LOUIS EUGENE BURTON, SAN MATEO, CA (US)

(73) Assignee: POC MEDICAL SYSTEMS INC, LIVERMORE, CA (US)

(21) Appl. No.: 15/881,792

(22) Filed: Jan. 28, 2018

Related U.S. Application Data
(63) Continuation of application No. PCT/US2016/045792, filed on Aug. 5, 2016.

(51) Int. Cl. B01L 3/00

(52) U.S. Cl. CPC B01L 3/502715; B01L 3/502738; B01L 2300/0861; B01L 2200/0605; B01L 2300/0803

(57) ABSTRACT

Aspects of the present disclosure are drawn to microfluidic devices. An exemplary microfluidic device may include a disc having at least one microfluidic channel pathway extending radially outward from a center of the disc. The channel pathway may include an inlet for receiving a sample, a first chamber fluidly connected to the inlet, and a second chamber positioned radially inward relative to and fluidly connected to the first chamber. The channel pathway may also include at least one third chamber positioned radially outward of the second chamber and fluidly connected to the second chamber via an outlet channel The channel pathway may include at least one fourth chamber fluidly connected to the at least one third chamber and positioned radially outward of the at least one third chamber. At least one of the first, second, third, or fourth chambers may contain at least one reagent pre-loaded into the disc.

This application claims the benefit of priority to PCT Application No. PCT/US2016/045792, filed on Aug. 5, 2016, which is incorporated by reference herein in its entirety.

### TECHNICAL FIELD

The present disclosure generally relates to microfluidic devices and systems useful in sample preparation, e.g., to assist in medical screening and/or diagnosis.

### BACKGROUND

Microfluidic devices and systems may be used for testing a biological sample from a subject for one or more analytes of interest. For example, the analyte(s) may be biomarkers that are associated with a health condition, such as a disease. Data on the presence or absence of various biomarkers, and the amount or level of each biomarker present in the sample, may be analyzed to obtain diagnostic information for the subject.

Microfluidic platforms may offer an attractive alternative to traditional laboratory testing for some applications. Microfluidic systems are generally characterized by a small instrument size, relatively low energy consumption, and relatively small volumes of biological samples and reagents needed for analysis. While these systems differ in their approaches to fluid movement and detection schemes, many offer inexpensive, fast, and easy-to-use alternatives to traditional diagnostic testing. Yet there continuously exists a need to decrease the volume of both sample and assay reagents needed for analysis and to decrease the complexity and size of microfluidic platforms while still promoting the precise movement of reagents and samples within the system. There is also a push to partially or entirely automate microfluidic systems and make them able to operate independently, without the assistance of external liquid handling devices. There also exists a need to decrease the cost and efficiency of microfluidic devices. Aspects of the present disclosure may address one or more of these deficiencies.

### SUMMARY

Aspects of the present disclosure are drawn to microfluidic devices. An exemplary microfluidic device may include a disc having at least one microfluidic channel pathway extending radially outward from a center of the disc. The channel pathway may include an inlet for receiving a sample, a first chamber fluidly connected to the inlet, and a second chamber positioned radially inward relative to and fluidly connected to the first chamber. The channel pathway may also include at least one third chamber positioned radially outward of the second chamber and fluidly connected to the second chamber via an outlet channel The channel pathway may include at least one fourth chamber fluidly connected to the at least one third chamber and positioned radially outward of the at least one third chamber. At least one of the first, second, third, or fourth chambers may contain at least one reagent pre-loaded into the disc.

According to some aspects of the present disclosure, the fluid connection between the first chamber and the second chamber may have a width that is narrower than a width of either the first chamber or the second chamber; the second chamber may be fluidly connected to a compression chamber positioned at a same or similar radial position relative to the second chamber; the outlet channel between the second chamber and the at least one third chamber may be curved and may include a radially inward curve and a radially outward curve; the at least one channel pathway may comprise a main channel joining the outlet channel to the at least one third chamber, the main channel extending in a direction transverse to a radial direction of the disc; the main channel may be in communication with an overflow channel for receiving fluid in excess of fluid entering the at least one third chamber; the fluid connection between the at least one third chamber and the at least one fourth chamber may include a first valve; the at least one channel pathway may further comprise at least one fifth chamber fluidly connected to the at least one fourth chamber and positioned radially outward of the at least one fourth chamber, the fluid connection between the fourth and fifth chambers including a second valve; the first valve may be configured to open in response to a first threshold of force, and the second valve may be configured to open in response to a second threshold of force, wherein the second threshold of force is greater than the first threshold of force; an end of the at least one microfluidic channel, proximate an edge of the disc, may be tapered; at least one sixth chamber may be fluidly connected to the at least one fourth chamber, wherein an end of the at least one sixth chamber defines the end of the at least one microfluidic channel; the at least one reagent pre-loaded into the disc may comprise a plurality of molecules attached to microbeads or a plurality of molecules attached to a wall of the disc; each molecule of the plurality of molecules may be configured to capture an analyte chosen from an oligonucleotide, a protein, or a small molecule; the at least one reagent pre-loaded into the disc may comprise a density medium; the at least one fourth chamber may comprise a plurality of fourth chambers in parallel; each fourth chamber may be in fluid communication with a respective fifth chamber and a respective sixth chamber; and the disc may comprise a plurality of channel pathways, each channel pathway extending radially outward from the center of the disc, and the center of the disc may include an aperture.

The present disclosure further includes a microfluidic device comprising a disc having at least one microfluidic channel pathway extending radially outward from a center of the disc. The at least one channel pathway may comprise an inlet for receiving a sample, a first chamber fluidly connected to the inlet, a second chamber fluidly connected to the first chamber, wherein the second chamber is positioned radially inward relative to the first chamber, an outlet channel fluidly connected to the second chamber and extending from the second chamber to a main channel located radially outward of the second chamber, and a plurality of third chambers fluidly connected to the main channel The at least one channel pathway may also comprise a plurality of fourth chambers, each fourth chamber being fluidly connected to, and positioned radially outward of, a respective third chamber, and a plurality of fifth chambers, each fifth chamber being fluidly connected to, and positioned radially outward of, a respective fourth chamber. At least one of the first, second, third, fourth, or fifth chambers contains at least one reagent pre-loaded into the disc.

According to some aspects of the present disclosure, each fifth chamber of the plurality of fifth chambers may contain a density medium; the second chamber may be fluidly connected to a compression chamber positioned at a same or similar radial position relative to the second chamber; the outlet channel includes a radially inward curve and a radially outward curve; the fluid connection between each third chamber and each fourth chamber may include a burst valve configured to open in response to a threshold of centrifugal force; the disc may comprise a plurality of channel pathways, each channel pathway extending radially outward from the center of the disc, and each channel pathway may comprise at least one reagent pre-loaded into the disc configured to capture an analyte chosen from an oligonucleotide, a protein, or a small molecule; and each channel pathway may comprise a plurality of molecules attached to microbeads or a plurality of molecules attached to a wall of the disc, the plurality of molecules of each channel pathway being configured to capture a different analyte than the other channel pathways.

The present disclosure is further drawn to a microfluidic device comprising a disc having at least one channel pathway extending radially outward relative to a central aperture of the disc. The at least one channel pathway may comprise an inlet for receiving a sample, a first chamber fluidly connected to the inlet, a second chamber fluidly connected to the first chamber, wherein the second chamber is positioned radially inward relative to the first chamber, wherein the fluid connection between the first chamber and the second chamber has a width narrower than a width of either the first chamber or the second chamber, and an outlet channel fluidly connected to the second chamber and extending from the second chamber to a main channel located radially outward of the second chamber, the main channel being in communication with an overflow channel for receiving excess fluid. The channel pathway may also comprise a plurality of third chambers, each third chamber being fluidly connected to, and extending radially outward from, the main channel, a plurality of fourth chambers, each fourth chamber being fluidly connected to a respective third chamber, wherein a valve is positioned in the fluid connection between each fourth chamber and each third chamber, and wherein each fourth chamber contains at least one reagent, a plurality of fifth chambers, each fifth chamber being fluidly connected to, and positioned radially outward of, a respective fourth chamber, wherein each fifth chamber contains a density medium, and a plurality of sixth chambers, each sixth chamber being fluidly connected to, and positioned radially outward of, a respective fifth chamber.

According to various aspects of the present disclosure, each fourth chamber may contain a plurality of molecules attached to microbeads, each molecule being configured to capture an analyte chosen from an oligonucleotide, a protein, or a small molecule; and each molecule may comprise an antibody configured to capture a biomarker of breast cancer.

The present disclosure is further drawn to a method of detecting at least one analyte of a fluid sample using the devices described herein. The method may include introducing the fluid sample into the inlet of the disc, rotating the disc, such that the fluid sample flows radially outward through the at least one channel pathway to combine with a plurality of capture molecules pre-loaded into the disc, and detecting a signal from the disc indicative of a presence of the at least one analyte. The fluid sample may comprise blood, and the at least one analyte may be a biomarker associated with a health condition.

### BRIEF DESCRIPTION OF THE DRAWINGS

The accompanying drawings, which are incorporated in and constitute a part of this specification, illustrate various exemplary embodiments and, together with the description, serve to explain the principles of the disclosed embodiments. Any features of an embodiment described herein (e.g., device, composition, system, method of manufacture, or process, etc.) may be combined with any other embodiment, and are encompassed by the present disclosure.

FIG. 1 shows an exemplary microfluidic disc, in accordance with some aspects of the present disclosure.

FIG. 2 shows an exemplary microfluidic disc, in accordance with some aspects of the present disclosure.

FIG. 3 shows a portion of an exemplary microfluidic disc, in accordance with some aspects of the present disclosure.

FIG. 4 shows an exemplary microfluidic disc, in accordance with some aspects of the present disclosure.

FIG. 5 shows exemplary components of a disc, in accordance with some aspects of the present disclosure.

FIG. 6 shows exemplary components of a microfluidic device or system, in accordance with some aspects of the present disclosure.

FIG. 7 shows an exemplary container of a microfluidic system, in accordance with some aspects of the present disclosure.

### DETAILED DESCRIPTION

Exemplary aspects of the present disclosure include microfluidic devices and systems useful in sample preparation, metering, mixing with reagents and/or sedimentation to capture analytes and separate captured analytes from reagents, and/or to determine the concentration of captured analytes. The devices and systems described herein may allow for automated processing and analysis of a sample for the detection of single and/or multiple analytes of interest that may be present in complex matrices, such as, e.g., blood.

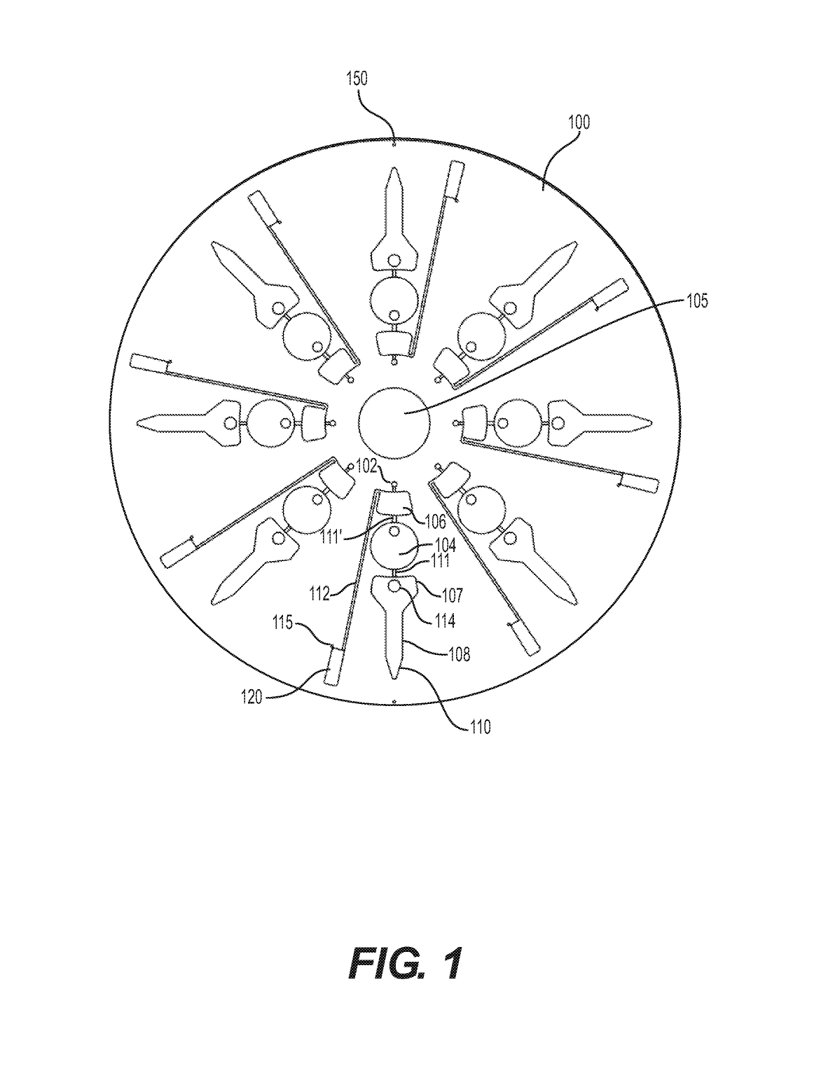

Movement of fluid(s) through the devices described herein may be achieved by applying centrifugal forces to the devices. Application of the appropriate centrifugal forces may allow movement of fluid(s) from one portion to another of the device through microfluidic circuitry incorporated into the device. The microfluidic circuitry may be designed to include valves between different portions of the devices to affect movement of a sample through the device. FIGS. 1-4 show exemplary discs comprising microfluidic channels and chambers, according to some aspects of the present disclosure, and are discussed in detail below. While FIGS. 1-4 illustrate several examples of combinations and configurations of microfluidic channels and chambers, it is understood that other combinations and configurations of channels and chambers are also encompassed herein. The present disclosure may include any of the features of a microfluidic disc disclosed in International Patent Application Nos. PCT/US2016/03059, filed on May 5, 2015, and/or PCT/US2016/038668, filed on Jun. 22, 2016, each of which is herein incorporated by reference in its entirety. Any features shown in connection to a particular example discussed herein may be used in combination with any other features discussed herein, including the features of any other example(s).

Aspects of the present disclosure include devices for testing a biological sample from a subject for one or more analytes (e.g., biomarkers) that are associated with a health condition, such as a disease. According to some aspects, exemplary devices may enable an operator to obtain data on the presence or absence of various biomarkers and the amount or level of each biomarker present in the sample to obtain diagnostic information for the subject.

In some aspects, the devices described herein may manipulate and/or process a sample to derive this data. For example, the device may be configured to treat the sample with one or more reagents, solubilize the sample, and/or enrich the sample for certain components. Enrichment of a sample may include, for example, concentrating one or more constituents of the sample to assist in detection, analysis, and/or identification of those constituent. In at least one example, the device may enrich a sample for one or more target proteins and/or polynucleotides of a sample prior to exposing the sample to reagents to capture molecules for binding and detecting the target(s).

Microfluidic platforms described herein may be an attractive alternative to traditional laboratory testing for some applications and may require relatively small volumes of biological samples and reagents needed for analysis. Microfluidic devices may reduce sample volume requirements from milliliters to microliters and may be self-contained platforms, providing for a reduced chance of cross-contamination and reduced biohazard risk. The small volume of sample and assay reagents needed for analysis may reduce the actual cost of performing the assay itself. For example, exemplary microfluidic devices according to the present disclosure may allow for reagents and samples to move precisely within microfluidic circuitry without the use of external liquid handling devices, as described further below. This may in turn reduce the complexity and/or cost of the instrumentation needed for running the assay. The smaller dimension of the platforms may also allow for smaller device footprints, and may open the possibility for the device to be portable. As a result, diagnostics may be more available for many applications and to many small laboratories and providers' offices.

Miniaturization of a process involving fluid migration is generally based on fundamental scaling principles. Microfluidic channels that hold only microliter amounts of liquid may create a specific hydrodynamic environment. For example, the flow of liquid may become laminar, which may in turn accelerate diffusive transport and contribute to more efficient mixing and microscale size reaction. Also, capillary forces (forces that exceed the force of gravity) acting on liquids in microchannels of a device may be used to fill a hydrophilic channel or to stop a propagating meniscus in front of a hydrophobic segment that may act as a valve. The integration of multiple on-board functions such as separation, metering, reaction, and detection into one device may offer the option to automate intensive manual operations. The reduced user interference during analysis (e.g., requiring little to no user input to conduct the assay) may increase the ease of use and/or reduce human error intrinsic to many experimental operations.

Devices and systems according to the present disclosure may combine compact disc (“CD” or “disc”) technology with microfluidic systems to achieve smaller-scale devices that partially or fully automate sample preparation and testing. In some aspects, the device may include microfluidic channels for performing a multiplex assay. On a microfluidic platform, for example, a relatively small volume of sample (e.g., on the order of microliters (μL)) may be sufficient to measure levels for a plurality of biomarkers. For example, the device may be a microfluidic-based immunoassay detection device comprising a microfluidic disc, a motor to control the spinning rate of the disc, and a detector such as an optical reader, e.g., to measure analytes. Centrifugal forces generated by spinning of a disc may open and close valves, e.g., hydrophobic valves, on microfluidic circuitry incorporated into the disc, which may control the precise movement of reagents and sample(s). The devices may use density media designed to separate captured analytes from reagents. Devices of the present disclosure may also eliminate one or more lengthy wash steps to allow for more rapid assay. Furthermore, the density media may allow for analytes to be concentrated into a small detection area, which may increase the sensitivity of the assay. Additionally, because CDs may be mass produced and are generally inexpensive to make, coupling CD technology with the advantages of microfluidics may result in a cost-effecting device and/or a streamlined device manufacturing processes. These features may provide for devices and systems that are more compact, less expensive, and/or more portable than current assay techniques.

Devices of the present disclosure may partially or fully automate sample preparation (e.g., plasma separation from blood), metering, mixing, incubation, sedimentation, and/or detection and quantification of one or more analytes present in the sample(s). The use of disc technology may allow for the possibility to multiplex a large number of samples, or conversely, to test for a large number of analytes (e.g., up to 60 biomarkers or more) per patient sample, in a single run, therefore reducing the processing time, the footprint of the device, consumables needed, and/or the power usage.

Control of the flow of sample fluid and reagents through the microfluidic may be achieved with valves, including, but not limited to, hydrophobic valves, capillary valves, burst seal valves, and/or Coriolis valves. In some aspects, the system may comprise a centrifugal microfluidic system that may accept a low volume sample of fluid containing analytes, possibly a relatively low concentration of analytes, which may be processed through physical and/or chemical/biochemical means to produce a signal indicative of (e.g., proportional to) the amount of analyte in the fluidic sample. Examples of fluidic samples that may be used in the centrifugal microfluidic devices of the present disclosure include bodily fluids (such as, e.g., blood and other bodily/biological fluids) and environmental fluids (such as, e.g., water from various naturally occurring water bodies) in which various biological entities may be detected. The biological entities detected may include, for example, proteins, viruses, cells, antibodies, genomic material (e.g., DNA, RNA, and fragments thereof, including microRNAs (miRNAs)), metabolites, small molecules, ions, pollutants, and/or biological organisms.

In the case of measuring the concentration of various analytes in human whole blood, non-plasma constituents among human blood samples of different sources can vary. Thus, for some applications, the plasma volume may be a more useful diagnostic measure for the analytes of interest. For example, the concentration of various analytes in blood plasma may be determined, such that a physician or other healthcare provider may be able to make meaningful inferences from the data. In some aspects, the devices of the present disclosure may include a blood separation step in which the plasma is separated from the other constituents, and is driven downstream for further processing and eventual detection. The possibility to access fresh, whole blood samples and immediately or promptly process them into plasma and immediately or promptly measure the analytes present in it, may allow for a more efficient and/or accurate measurement of a wide set of analytes. This may be useful for analytes that may degrade if blood or plasma is stored for a long period of time before analysis.

The singular forms “a,” “an,” and “the” include plural reference unless the context dictates otherwise.

The terms “approximately” and “about” refer to being nearly the same as a referenced number or value. As used herein, the terms “approximately” and “about” generally should be understood to encompass ±5% of a specified amount or value.

The terms “analyte” and “target” are used interchangeably herein and may include, but are not limited to, a molecule of interest that is to be detected and/or analyzed. Non-limiting examples include ions, small molecules, proteins, viruses, cells, antibodies, genomic material (e.g., DNA, RNA, and fragments thereof, including miRNAs), metabolites, nucleic acids, pollutants, and biological organisms. In some aspects of the present disclosure, an analyte of interest may be biomarker.

The term “biomarker” generally refers to a chemical or biochemical indicator associated with one or more health conditions. A biomarker may include, but is not limited to, a molecule of interest or a portion of a molecule of interest that is to be detected and/or analyzed. Exemplary biomarkers include, e.g., peptides, proteins, DNA sequences, and RNA sequences. The terms “polypeptide,” “oligopeptide,” “peptide,” and “protein” may be used interchangeably herein to refer to polymers of amino acids of any length that may or may not include chemical modifications. Such a polymer may be linear or branched, may comprise modified amino acids, and/or may be interrupted by non-amino acids. The amino acid polymers may be modified naturally or by intervention. For example, amino acid polymers according to the present disclosure may be modified by disulfide bond formation, glycosylation, lipidation, acetylation, phosphorylation, or any other manipulation or modification, such as conjugation with a labeling component. The amino acid polymers may include polypeptides comprising one or more analogs of an amino acid (including, for example, unnatural amino acids), as well as other chemical/biochemical modifications known in the art. In some aspects of the present disclosure, the microfluidic systems and devices may be used to detect and/or analyze biomarkers indicative of cancer (e.g., breast cancer, prostate cancer, ovarian cancer, and/or other type of cancer), a heart/cardiac disease, a neurological disease, a respiratory disease, and/or infectious diseases such as sexually transmitted diseases (STDs).

Biomarkers that may be detected and/or analyzed according to the present disclosure include, but are not limited to, human estrogen receptor 2 (Her-2), matrix metallopeptidase-2 (MMP-2), matrix metalloproteinase 9 (MMP-9), cancer antigen 15-3 (CA 15-3), cancer antigen 125 (CA 125), cancer antigen 27.29 (CA 27.29), carcinoembryonic antigen (CEA), vascular endothelial growth factor (VEGF), epidermal growth factor (EGF), hepatocyte growth factor (HGF), tumor specific growth factor (TSGF), tumor specific growth factor (TSGF), osteopontin (OPN), tumor protein p53 (p53), serum estrogen receptor (SER), serum progesterone receptor (SPR), BRCA 1 protein, BRCA 2 protein, prostate specific antigen (PSA), troponin T, troponin I, C-reactive protein (CRP), homocysteine, myoglobin, creatine kinase, adrenocorticotropic hormone (ACTH), alpha-fetoprotein (AFP), anterior gradient 3 (AGR3), apolipoprotein A1 (Apo-A1), D-dimer (DD), dermcidin, high molecular weight kininogen (HMWK), leptin, myeloperoxidase (MPO), macrophage migration inhibitory factor (MIF), mucin-like carcinoma associated antigen (MCA), plasminogen activator inhibitor-1 (PAI-1), prolactin, soluble CD40 ligand (sCD40L), soluble epidermal growth factor receptor (sEGFR), soluble vascular cell adhesion molecule 1 (sVCAM-1), soluble vascular endothelial growth factor receptor 1 (sVEGFR1), soluble vascular endothelial growth factor receptor 2 (sVEGFR2), tissue polypeptide antigen (TPA), thymidylate synthase (TS), urokinase plasminogen activator (uPA), vitamin D-binding protein (VDBP), and vitronectin (VN).

Exemplary biomarkers for a prostate cancer panel (e.g., biomarkers useful in obtaining diagnostic information regarding prostate cancer) may include, but are not limited to, PSA. Exemplary biomarkers for an ovarian cancer panel (e.g., biomarkers useful in obtaining diagnostic information regarding ovarian cancer) may include, but are not limited to, CA 125. Exemplary biomarkers for a heart disease panel (e.g., biomarkers useful in obtaining diagnostic information regarding heart disease) may include, but are not limited to, troponin T, troponin I, CRP, homocysteine, myoglobin, and/or creatine kinase. Exemplary biomarkers for a respiratory disease panel (e.g., biomarkers useful in obtaining diagnostic information regarding respiratory disease) may include, but are not limited to, influenza A, influenza B, and respiratory syncytial virus (RSV). In some aspects of the present disclosure, the biomarkers of a panel may be associated with, or otherwise indicative of, pathogens (e.g., bacteria, viruses, parasites) linked to STDs and/or other infectious diseases. In some examples, the biomarkers of a panel may be associated with, or otherwise indicative of, antibiotic resistance to one or more pathogens.

In some examples, the targets or analytes to be detected may be biomarkers associated with breast cancer. For example, the biomarkers may include human estrogen receptor 2 (Her-2), matrix metallopeptidase-2 (MMP-2), cancer antigen 15-3 (CA 15-3), osteopontin (OPN), tumor protein p53 (p53), vascular endothelial growth factor (VEGF), cancer antigen 125 (CA 125), serum estrogen receptor (SER), or a combination thereof. Examples of sequence identifiers in the HUGO Gene Nomenclature Committee on-line database for such markers include, but are not limited to, Her-2 (X03363), MMP-2 (NM_004530), OPN (NM_001040058), p53 (NM_000546), VEGF (MGC70609), CA 125 (Q8WX17), SER (NP 000116.2), and CA 15-3 (NM_002456).

Any of the foregoing biomarkers can include fragments, splice variants, and/or full length peptides, or any other variations. It is understood that the present disclosure is not limited to the biomarkers listed, and additional biomarkers are encompassed and contemplated for the systems, devices, and methods herein.

The term “capture molecule” generally refers to a molecule that may bind to an analyte or target (e.g., a target molecule, such as a biomarker). For example, a capture molecule may have one binding site, or a plurality of two or more binding sites complementary to an analyte or target. Capture molecules according to the present disclosure may be capable of binding to only one target (e.g., the capture molecule being specific to one particular target), to a select number of targets (e.g., the capture molecule being specific to two or more targets), or to a plurality of target and non-target species. Exemplary biomarkers and capture molecules, as well as potential binding between the two, are described in further detail in International Patent Application Nos. PCT/US2016/03059 and PCT/US2016/038668, each herein incorporated by reference in its entirety.

The capture molecule(s) may include, for example, one or more antibodies, peptides, proteins, or a combination thereof. Exemplary capture molecules suitable for the present disclosure include, but are not limited to, RNA, DNA, peptides, antibodies, aptamers, and protein-based aptamers. In at least one embodiment, the capture molecule is an antibody. In some aspects of the present disclosure, capture molecules may be blocked using blocking agents such as, e.g., serum, serum diluted in phosphate buffered saline (PBS), and other blocking agents known in the art. In some examples, the capture molecule(s) may comprise an oligonucleotide, an aptamer, a chimeric structure comprising one or more oligonucleotide sequences, or an antibody.

In some aspects of the present disclosure, a target or analyte may bind to a capture molecule, e.g., an aptamer. A molecule or other chemical/biochemical species may be said to exhibit “binding” if it reacts or associates more frequently, more rapidly, with greater duration and/or with greater affinity with one or more particular analyte(s) than with alternative substances (e.g., other analytes or non-target analyte species). For example, a capture molecule may “bind” to a target if it attaches to the analyte with greater affinity, avidity, more readily, and/or with greater duration than it attaches to other substances. In at least one example, the capture molecule may comprise an oligonucleotide that specifically or at least preferentially binds to an analyte (e.g., a biomarker) with greater affinity, avidity, more readily, and/or with greater duration than the oligonucleotide binds to other substances.

In at last one example, the capture molecule comprises an aptamer. The aptamer may comprise, for example, a single-stranded oligonucleotide (e.g., DNA or RNA) capable of binding to an analyte by structurally conforming to the analyte. The aptamer may be highly specific to, and form a strong bond with, an analyte.

The terms “nucleic acid,” “oligonucleotide,” and “genomic material” may be used interchangeably herein to refer to oligomers of nucleic acids of any length. Such oligomers may be linear or branched, may comprise modified nucleic acids, and/or may be interrupted by one or more non-nucleic acids.

The term “detect” may refer to identifying the presence, absence and/or amount of analyte to be detected. Detection may be performed visually and/or using any suitable device, such as, e.g., a scanner and/or detector. The term “analyze” may include, but is not limited to, determining a value or a set of values associated with a given sample by a measurement. For example, analyzing according to aspects of the present disclosure may include measuring constituent expression levels in a sample and comparing the levels against constituent levels in a sample or set of samples from the same subject or other subject(s).

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The term “exemplary” is used in the sense of “example” rather than “ideal.”

Exemplary Devices

Devices suitable for various aspects of the present disclosure may provide for point-of-care testing, e.g., to obtain diagnostic information for a patient at or near the time and place of patient care. For example, the device may be portable and/or self-contained. Further, devices according to the present disclosure may be used to measure multiple analytes or targets (e.g., biomarkers) simultaneously, in a multiplex assay. Exemplary assays that may be performed on the devices disclosed herein and other exemplary devices are described in further detail in International Patent Application Nos. PCT/US2016/03059, filed on May 5, 2015, and PCT/US2016/038668, filed on Jun. 22, 2016, each of which is herein incorporated by reference in its entirety.

Exemplary microfluidic discs may have one or more microfluidic channels and/or one or more chambers through which fluid flows. The channel or channels of the microfluidic disc may be any suitable shape including, but not limited to, a cross-sectional shape that is round, curved, trapezoidal, triangular, or other suitable geometric shapes. Channel sizes and/or shapes may be selected according to a given application. In some aspects, the channels may range from about 0.1 microns to several millimeters deep, and from about 0.1 microns to several millimeters or centimeters wide. The channels may be straight, angled, curved, zig-zag, U-shaped, a combination thereof, or other configurations, e.g., depending upon the application and the function of the channels. The capacity of a channel may range from nanoliters to 1 milliliter or more, depending upon the application.

The disc may also include one or more chambers in which reagents, sample, sample extracts, or other materials or fluids. Reagents or other materials may be stored in one or more channels and/or chambers and may be mixed with a sample for performing a multiplex assay. Some chambers may be arranged relative to the other chambers and/or channels so that portions of the sample are diverted and/or separated into constituent parts. Some channels and/or chambers may be arranged relative to each other so as to promote mixing or agitation of the sample. One or more channels or chambers may be oriented in a radially or azimuthal zig-zag pattern to promote mixing of the sample with the reagent(s). In some examples, the channels and/or chamber walls may include physical structures that define a serpentine path. Additionally or alternatively, the walls may include one or more angles, projections, or recesses to agitate or otherwise affect the flow of fluid to encourage mixing.

In some aspects, the device may be a disc that includes microfluidic circuitry with multiple chambers, and one or more channels may connect with one or more chambers to allow fluid to flow between the channel(s) and chamber(s). The microfluidic disc may provide the channel(s) through which fluid flows and the chambers where reagents are stored and/or mixed with a sample added to the disc in a diagnostic assay. Microfluidic discs of the present disclosure may depend on centrifugal force to move and/or mix the sample and/or reagents through the one or more channels and interconnected chambers.

Different chambers included on a disc may be designed for different functions. Exemplary functions of the chambers include, but are not limited to, sample collection, sample preparation, sample sedimentation, reagent reservoir, volume metering, mixing, incubation, reaction, sample/reagent sedimentation, filtration, detection, and/or waste collection. Additionally, some chambers may perform multiple functions. Each chamber may be of any suitable shape, including, e.g., a cross-sectional shape that is round, oval, square, rectangular, trapezoidal, triangular, or other geometric shapes. In some embodiments, the chambers may range from about 0.1 microns to several millimeters deep and from about 0.1 microns to several millimeters or centimeters wide. The capacity of a chamber may range from nanoliters to milliliters or more, depending upon the application. Two or more chambers may be connected or otherwise in fluid communication with each other, e.g., to allow for movement of fluids from one chamber to another, to obtain a workflow of operations for the detection, analysis, and/or quantitation of analytes of interest present in the sample(s).

An exemplary microfluidic system according to the present disclosure may require a relatively small volume of sample (e.g., on the order of microliters (μL)) to measure levels for one or more analytes. For example, the device may be a microfluidic-based immunoassay detection device comprising a microfluidic disc, a motor to control the spinning rate of the disc, and a detector such as an optical reader, e.g., to measure analytes.

In some embodiments, the microfluidic disc may contain reagents stored in the disc for capturing analytes of interest of a sample and/or a suitable set of other reagents for binding, detection, and separation processes. For example, the microfluidic disc may comprise capture molecules attached to a substrate such as a plurality of microbeads, or attached to an inner surface of the disc to form a microarray. Any features of microbeads and microarray substrates discussed in International Patent Application Nos. PCT/US2016/03059 and/or PCT/US2016/038668, each incorporated by reference herein, may be used for the present disclosure. Microfluidic devices according to the present disclosure may also include any of the features disclosed in U.S. Provisional Application No. 62/157,878, filed on May 6, 2015, and U.S. Provisional Application No. 62/183,294, filed on Jun. 23, 2015, each of which is incorporated by reference herein in its entirety.

In some aspects of the present disclosure, one or more capture molecules may be attached to, e.g., immobilized on, a surface. As used herein, the term “immobilized” includes being immobilized, bound, and/or linked to a surface, such as, e.g., a microbead, a wall of the device (e.g., the wall of a chamber or of a microfluidic channel) or a substrate coupled to a wall of the device.

In at least some examples, the capture molecules may be attached to, or immobilized on, microbead surfaces. A microbead may be a particle having a generally curved shape. In at least one example, the microbeads may be spherical with a uniform diameter. Microbeads according to the present disclosure may be rigid, and may have a surface that is smooth or porous, or that includes both smooth portions and porous portions. A microbead may comprise one material or a combination of materials. The microbeads may have magnetic properties in some embodiments, e.g., the microbeads comprising a magnetic material or combination of materials. According to some aspects of the present disclosure, the microbeads may have an average diameter between about 10 nm and about 100 μm, such as from about 50 nm to about 50 μm, from about 100 nm to about 10 μm, from about 100 nm to about 5 μm, from about 500 nm to about 5 μm, from about 100 nm to about 1 μm, from about 1 μm to about 50 μm, from about 5 μm to about 10 μm, or from about 10 μm to about 50 μm. For example, the microbeads may have an average diameter of about 10 nm, about 100 nm, about 500 nm, about 1 μm, about 5 μm, about 10 μm, about 50 μm, or about 100 μm.

In some examples, the capture molecules may be attached to, or immobilized on a surface to form a microarray. A plurality of capture molecules specific to the same target may be grouped together in close proximity to one another, forming a “feature” of the microarray. Thus, for example, the microarray may include one or more features for detection of the same analyte. In some aspects, the microarray may include multiple features for detection of different types of analytes, e.g., each feature comprising a plurality of capture molecules specific to an analyte. Each feature may range from about 10 μm to about 500 μm in cross-sectional size, such as from about 50 μm to about 100 μm, from about 75 μm to about 250 μm, or from about 100 μm to about 200 μm, e.g., a cross-sectional size of about 10 μm, about 50 μm, about 75 μm, about 100 μm, about 150 μm, about 200 μm, or about 250 μm. In some examples, the microarray may include 1 feature to 1 million features or more, such as from 5 to 10,000 features, from 10 to 1,000 features, or from 100 to 500 features. Further, for example, the microarray may include from 2 to 48 features, from 5 to 30 features, or from 8 to 25 features. The configuration of the microarray may be selected based on the number of features desired, the number and/or types of analytes to be detected, and/or the available space on the surface of the substrate (e.g., the space available in the chamber or chambers of the disc to contain the microarray). In some examples, the features may be arranged in a regular pattern, such as in a rectangular, square, circular, triangular, or hexagonal pattern, or a combination thereof. For example, the microarray may have a grid-like configuration of 9 features (e.g., 3×3 square, or concentric circles of 5 and 4), 12 features (e.g., 3×4 rectangle), 16 features (e.g., 4×4 square), 20 features (e.g., 4×5 rectangle), or 25 features (e.g., 5×5 square). Each channel may include one microarray or a plurality of microarrays.

Linking of a capture molecule to a surface may be covalent or non-covalent, and may be achieved by any suitable method(s). For example, the surfaces of the microbeads or other surface for forming a microarray may be functionalized with one or more chemical functional groups, e.g., to be conjugated to capture molecules. Exemplary functional groups include, but are not limited to, amine, thiol, phosphate, alkyl, alkene, alkyne, arene, alcohol, ketone, aldehyde, carboxyl, and alkoxy groups. In at least one example, the surface serving as a substrate may be conjugated to antibodies, or any other capture entity as described herein.

Different types of capture molecules may be attached to the same substrate surface (e.g., for capture and detection of different targets), or the substrate may include only one type of capture molecule. For example, when microbeads (also referred to herein as “beads”) are used as substrates, a plurality of microbeads may include the same type of capture molecule, such that the microbeads are specific to one target. Each microbead of the plurality of microbeads may have the same size, shape, and chemical composition as the other microbeads, or the plurality of microbeads may include at least one microbead having a different size, shape, and/or chemical composition than at least one other microbeads of the plurality of microbeads. Similarly, a surface of a chamber or channel of a microfluidic device may include a plurality of capture molecules of the same type, or the surface may be divided into two or more areas (e.g., defining multiple discrete features on the surface to form a microarray), each comprising a different type of capture molecule.

Further, some microfluidic discs according to the present disclosure may not use microbeads or a microarray for detection of analytes. For example, the disc may include an amplification and detection chamber as disclosed in International Patent Application No. PCT/US2016/038668, filed on Jun. 22, 2016, incorporated by reference herein in its entirety. The reaction chamber 104 and/or the amplification and detection chamber may contain reagents for amplification of one or more target oligonucleotide(s) in the sample. The amplified targets then may be detected, e.g., without use of a substrate. In some examples, the amplification reaction may generate a byproduct (e.g., phosphate), which may be insoluble in the sample fluid. In such cases, the progression of the reaction may be monitored, e.g., by measuring turbidity in the amplification and detection chamber over time. In other examples, the amplification and detection chamber may contain capture molecules having specific, relatively short sequences that have a quencher and a detectable tag (e.g., a fluorescent tag) in proximity to each other. When the capture molecules are in presence of a complementary target sequence, they may hybridize to the target, and by doing so, the quencher and the detectable tag may be pushed apart. Once the detectable tag is apart from the quencher, the tag may be allowed to generate signal. For example, a fluorescent tag may be allowed to emit light.

In some embodiments, movement of fluids from chamber to chamber may be achieved by creating a valving system. The valving system may include relatively narrow channels, e.g., to regulate fluid flow or promote capillary action. In some aspects, the valving system may be actuated by centrifugal force. For example, one or more valves may be located between a chamber and a channel, within a channel, or between sections of a chamber. A microfluidic disc may include a valve located between a sample preparation chamber and a metering and reaction chamber, and/or between a metering and reaction chamber and a separation chamber. Valves may provide resistance to fluid flow through the channels until enough force is provided to overcome such resistance. Spinning the disc at a determined speed may provide enough force to overcome such resistance. For example, a valving system may be designed so that rotation of the disc below or above a threshold speed may provide enough force to overcome the resistance, allowing fluid to flow through the valve. In this way, rotational speed may be used to control fluid flow on the disc. Each valve may be designed or adjusted to correspond to a particular rotational speed or speeds, e.g., such that different chambers may be selectively accessed to move the fluid at a desired time according to the operations of the device.

In other aspects, instead of, or in addition to valves, one or more breakable seals may be included on exemplary discs disclosed herein in order to control the flow of fluid. Other suitable flow-control mechanisms may include, e.g., breakable seals that may be shattered, punctured, or otherwise broken by the application of force. For example, the seal may be broken by a pin or protrusion included in the disc. Alternatively, such seals may be broken by rotating the disc above a certain speed to create a suitable centrifugal force capable of breaking the seal. In some aspects, a deformable plug, e.g., comprising a meltable material such as a wax plug, may be used, and heat may be applied to melt the plug and to allow fluid to pass through. The plug may be solid below a certain operational temperature, and after heating of the disc or a portion of the disc, the plug may melt to allow fluid to flow through the channel and/or chamber and continue along the channel pathway.

Exemplary devices of the present disclosure may be configured to operate according to disc rotation in a predetermined manner, e.g., to mix the sample with reagents. For example, when a sample is introduced to a chamber, such as a mixing and/or an incubation chamber, the disc may be rotated at different speeds or in different directions in order to promote mixing. For example, in some aspects, the discs described herein rotate in alternating directions, e.g., between clockwise and counterclockwise, during an assay. In some aspects, the discs may be rotated between a higher rotational speed and a lower rotational speed. In general, the rotational speed of microfluidic disc may range from 50 RPM to 20,000 revolutions per minute (RPM), such from 100 RPM to 16,000 RPM, from 200 RPM to 5,000 RPM, or from 500 RPM to 10,000 RPM. In some aspects, the lower speed may be 0 RPM, i.e., the disc may be stopped or stationary. The rotational speed used for any given assay or step of an assay may depend on the characteristics of the disc used (e.g., shapes, sizes, and/or arrangement of channels, chambers, and/or other components of the disc), the type of assay to be run, the amount of desired mixing between sample and reagent(s), the materials out of which the disc is made, or any additional features or combinations thereof.

In some aspects, mixing may be achieved by having a chamber in fluidic communication with one or more mixing chambers, e.g., a second mixing chamber placed radially outward of a first mixing chamber into which fluid will flow, e.g., be pushed by centrifugal force, when the disc is rotated above a given speed, as described herein. In some aspects, fluid present in the disc may compress air or other gas(es) present in the second mixing chamber, which may then expand and push back on the fluid when the rotational speed is reduced. Rotation may be controlled in order to control the flow of fluid in such discs.

The microfluidic discs herein may be made of any material or combination of materials suitable for a desired assay. For example, the microfluidic disc may comprise one or more polymers or copolymers. Exemplary materials suitable for the microfluidic discs herein include, but are not limited to, polypropylene, polystyrene, polyethylene, acrylates such as poly(methyl methacrylate) (PMMA), cyclic olefin polymers (COP), cyclic olefin copolymers (COP), polydimethylsiloxane (PDMS), polyacrylamides, and combinations thereof. Other materials are also contemplated herein, such as metals, metal alloys, and ceramics.

In some embodiments, the material(s) of the microfluidic disc may be made opaque, e.g., by applying a coating, which may limit the area for optical detection to one or more specific areas of the disc. Alternatively, the material(s) may be already opaque and portions may be made transparent, e.g., by polishing the surface or by other suitable methods. In some embodiments, the disc circuitry or a portion thereof may be coated to complement or improve hydrophilic or hydrophobic characteristics of the material(s) used. For example, surfaces of the channels and/or chambers may be completely or partially coated. The coating may facilitate movement of the fluid and/or may refine the valving effect in controlling movement of the fluids.

In some embodiments, the disc circuitry or a portion thereof may be coated with a material or combination of materials to improve one or more of reaction, mixing, or detection steps, and/or other functions according to the operation of the appropriate workflow for detection, analysis and/or quantitation of the analytes of interest present in a sample. The coating material(s) may be in solution form for application to the disc. Exemplary coating solution or solutions may comprise, for example, surfactants, salts, small molecules, oligonucleotides, proteins, or a combination thereof.

FIG. 1 shows an exemplary microfluidic disc 100 comprising multiple microfluidic channel pathways, each including a series of interconnected chambers through which fluid may flow during an assay. The number, sequence, and design of the chambers may be tailored to the particular analytes or targets being detected and the reagents used. As shown, for example, each channel pathway may include a sample inlet 102, a metering chamber 106, a reaction chamber 104, an upper separation chamber 107, a separation chamber 108, and a detection chamber 110. The upper separation chamber 107 and/or the reaction chamber 104 may include a vent (similar to vent 115, discussed below). The vent(s) may allow air to escape to equalize pressure as air enters the chambers and/or may allow gaseous by-products produced during reactions to vent from the disc 100. The disc 100 may also include a central aperture 105, e.g., for coupling the disc 100 to a powered component to drive rotation of the disc 100 during an assay to create centrifugal force for moving the sample through the channels and chambers. Metering chamber 106 of disc 100 is positioned adjacent the sample inlet 102 and is connected by an overflow channel 112 to a waste chamber 120. Disc 100 may also include one or more markers, e.g., a reference marker 150 to indicate to a detector and/or an operator which channel pathway is the first channel pathway on the disc in order to aid in distinguishing each channel pathway from the others.

In an exemplary testing procedure, a sample, e.g., a blood sample that is suspected of comprising one or more biomarkers of interest is added to the sample inlet 102 of the microfluidic disc 100. A sample may comprise blood and/or other liquid samples of biological origin, solid tissue samples such as a biopsy specimen, tissue culture, or cells derived therefrom, and the progeny thereof. A sample may comprise a single cell or more than a single cell, e.g., a plurality of cells. Samples may include clinical samples, cells in culture, cell supernatants, and/or cell lysates. The sample may be manipulated or processed by one or more procedures or treatment steps after their procurement from a subject. For example, a sample may be treated with one or more reagents, solubilized, and/or enriched for certain components. Enrichment of a sample may include, for example, concentrating one or more constituents of the sample to assist in detection, analysis, and/or identification of those constituent.

In general, an aliquot of raw sample (e.g., whole blood or other biological fluid) ranging from about 1 μL to about 300 μL or more (˜one to several drops) may be added to the inlet, such as from about 1 μL to about 280 μL, from about 1 μL to about 250 μL, from about 1 μL to about 220 μL, from about 1 μL to about 200 μL, from about 1 μL to about 180 μL, from about 1 μL to about 150 μL, from about 1 μL to about 120 μL, from about 1 μL to about 100 μL, from about 1 μL to about 80 μL, 1 μL to about 80 μL, from about 1 μL to about 40 μL, from about 1 μL to about 20 μL, from about 1 μL to about 6 μL, from about 20 μL to about 250 μL, from about 20 μL to about 200 μL, from about 50 μL to about 100 μL, from about 50 μL to about 250 μL, from about 100 μL to about 200 μL, from about 5 μL to about 80 μL, or from about 2 μL to about 5 μL. For example, an aliquot of sample of about 1 μL, about 2 μL, about 3 μL, about 4 μL, about 5 μL, about 6 μL about 20 μL, about 40 μL, about 60 μL, about 80 μL, about 100 μL, about 120 μL, about 150 μL, about 180 μL, about 200 μL, about 220 μL, about 240 μL, about 250 μL, about 280 μL, or about 300 μL may be used. As the disc rotates, the sample may flow through the channel pathway, radially outward.

In some embodiments, the sample inlet(s) 102 or other portions of the circuitry of disc 100 may be coated with one or more anticoagulant agents, such as, e.g., K2EDTA, Na2EDTA, or heparin, or other suitable anticoagulant agents.

In some embodiments, the sample may pass from the sample inlet 102 into metering chamber 106 as the disc rotates. Once metering chamber 106 is filled with sample, excess sample may be diverted into overflow channel 112 and may be collected in waste chamber 120. For example, once metering chamber 106 is full, additional sample introduced into the sample inlet 102 may follow the path of least resistance into overflow channel 112. Centrifugal force and/or capillary action may promote movement of excess sample radially outwards down overflow channel 112 into waste chamber 120. Inclusion of metering chamber 106 may reduce the need to input a precise amount of sample into the sample inlet 102, because excess sample may be diverted to waste chamber 120 and prevented from entering the assay portion of disc 100. Waste chamber 120, or any portion of disc 100, may include one or more vents 115 to equalize pressure as the chambers and/or channels fill with sample.

In some embodiments, the microfluidic discs herein may include a valving system and/or relatively narrow channels, e.g., to regulate fluid flow. For example, the microfluidic disc 100 of FIG. 1 may include at least one valve 111 or 111′, e.g., between the reaction chamber 104 and the upper separation chamber 107 and/or between the upper separation chamber 107 and the separation chamber 108 and/or between the metering chamber 106 and the reaction chamber 104. As shown, for example, the disc 100 may include a valve 111′ between the metering chamber 106 and the reaction chamber 104, and a valve 111 between the reaction chamber 104 and the upper separation chamber 107. The valves 111, 111′ may be the same type of valve or may be different. Valves may provide resistance to fluid flow through the channels until enough force is provided to overcome such resistance. An example of force to overcome such resistance may include centrifugal force applied by spinning the disc at threshold speed. Each valve may be designed or adjusted to correspond to a particular rotational speed or speeds, e.g., such that different chambers may be selectively accessed to move the fluid at a desired time according to the operations of the device.

In one exemplary aspect, valves 111′, 111 of disc 100 may include burst valves. Rotation of disc 100 below a threshold rotational speed may prevent sample from flowing from metering chamber 106 to reaction chamber 104, while rotation above the threshold may provide enough centrifugal force to open the first valve 111′, allowing the sample to flow between the chambers. Likewise, rotation of disc 100 below a threshold rotational speed may prevent sample from flowing from reaction chamber 104 to upper separation chamber 107, while rotation above the threshold may provide enough centrifugal force to open the second valve 111, allowing the sample to flow between the chambers. In some aspects, the amount of force required to open the valve 111′ between metering chamber 106 and reaction chamber 104 may be less than the amount of force required to open valve 111 between reaction chamber 104 and upper separation chamber 107. Phrased differently, it may take a lower threshold rotational speed to open valve 111′ than to open valve 111.

For example, burst valve 111′ may open in response to rotation above a threshold of approximately 1,000 RPM, while burst valve 111 may open in response to rotation above a threshold of approximately 2,000 RPM. While the threshold to open valves 111′ and 111 may change according to the disc type, exemplary speeds required to open the first valve 111′ may range from approximately 1,000 RPM to approximately 2,000 RPM, while the second valve 111 may open in response to rotation above a threshold speed of approximately 1,500 RPM to approximately 3,000 RPM. Generally, though, the rotational speed required to open the first valve 111′ may be lower than the rotational speed required to open the second valve 111. This may prevent fluid from flowing from metering chamber 106, straight through reaction chamber 104, and into upper separation chamber 107. By requiring a higher speed to exit the reaction chamber 104 than to enter reaction chamber 104, sample may be contained within reaction chamber 104 until the time at which the higher speed is achieved, providing increased control of fluid flow.

The metering chamber 106 may provide for pre-processing of the sample prior to mixing the sample with reagents stored in the disc 100. For example, various components of the sample may be separated, e.g., via a filter, such that only a portion of the original sample may flow through the channel for analysis. For example, the sample inlet 102 may be configured to separate whole blood into plasma, serum, and cell components. In some examples, the amount of sample component (e.g., blood plasma) mixed with reagents for analysis may generally range from about 1 μL to about 6 μL. For example, the amount of sample or sample component sufficient for a multiplex assay according to the present disclosure may range from about 2 μL to about 5 μL, e.g., an aliquot of sample of about 1 μL, about 2 μL, about 3 μL, about 4 μL, about 5 μL, or about 6 μL. Excess sample and/or any components of a raw sample not used for analysis may be separated into the waste chamber 120.

Reaction chamber 104 may contain reagents that may be mixed with the sample as the sample enters the reaction chamber. The term “reaction chamber” is intended to encompass a chamber in which various types of reactions and/or other interactions between analytes and reagents pre-loaded into the disc may occur, and should not be construed as limited to a particular type of chemical reaction or interaction. For example, the reaction chamber 104 may include reagents designed for binding or hybridization to a target, and/or reagents designed for amplification of a target. Thus, for example, capture molecules attached to microbeads and/or primer oligonucleotides for an amplification reaction may be included in the reaction chamber 104. The reaction chamber 104 may combine the sample with the capture molecules, e.g., for binding targets to the capture molecules. Thus, for example, reagents comprising capture molecules attached to microbeads may be pre-loaded and stored in the disc prior to an assay. Reagents other than the capture molecule-microbeads may be present in liquid, gel or lyophilized form, such that the capture molecule/microbeads are suspended in the liquid, gel, or lyophilized material(s). When a portion of the reagents are lyophilized, the sample or sample component introduced into the reaction chamber 104 (e.g., blood plasma) for analysis may reconstitute the lyophilized material(s).

If the assay includes multiple reaction steps, the disc 100 may include two or more reaction chambers 104 in sequence, each reaction chamber 104 including the appropriate reagents for the reaction. For example, the disc 100 may include two or more reaction chambers 104 for performing various steps of the assay, e.g., a first reaction chamber 104 containing a first set of reagents for amplification of a target, followed by a second reaction chamber 104 containing a second set of reagents for binding of the amplified target with capture molecules. The reaction chamber(s) 104 may be in communication with one or more waste chambers similar to waste chamber 120 for receiving and storing excess sample and/or reagents.

In some aspects, the reaction chamber 104 may function as an incubation chamber. For example, in some aspects, the reaction chamber 104 may comprise one or more detection-specific reagents and/or one or more capture reagents pre-loaded into the disc 100, and the reagents may be combined with the sample in the reaction chamber 104 for a pre-determined period of time (i.e., the incubation time). The incubation time may be controlled, e.g., by controlling the rotational speed of disc 100, through the use of valves, by the size and/or shape of the chambers and/or interconnected channels. As described above, sample may be released from metering chamber 106 into reaction chamber 104 via valve 111′ when disc 100 is spun above a threshold rotational speed. The sample may then remain in reaction chamber 104 until disc 100 is spun above a second, higher, threshold rotational speed to open valve 111. Thus, controlling the rotational speed of disc 100 may control the length of the incubation time in reaction chamber 104. In some aspects, incubation time may range from several seconds to several minutes or longer, depending on the type of assay being used. For example, the incubation time may range from about 1 second to about 20 minutes or longer, such as from about 3 seconds to about 1 minute, from about 5 seconds to about 30 seconds, from about 1 minute to about 15 minutes, or from about 10 minutes to about 15 minutes.

While the sample is in reaction chamber 104, disc 100 may be spun in alternating clockwise and counterclockwise directions to promote mixing. The rotational speed of disc 100 during the alternating clockwise and counterclockwise mixing process may be maintained below the threshold rotational speed required to open valve 111, preventing the sample from exiting reaction chamber 104 until the mixing and/or incubation process is complete. Control of incubation time and mixing between sample and reagent(s) described herein may also apply to discs 200, 300, and 400, described below.

In some aspects, the incubation of a sample may be performed sequentially. For example, incubation may first occur with one or more capture reagent(s), and after predetermined amount of time, one or more detection reagent(s) may be released or activated into the reaction chamber 104. For example, a detection reagent may be contained within the reaction chamber 104 in an inactivated state. In some aspects, irradiation, such as heat, light, or other forms of energy transfer, may be used to activate the stored detection reagent. For example, a detection reagent may be stored in the reaction chamber 104 in an inactive form by protecting the reagent with a photogroup. The photogroup may prevent interaction of the detection reagent with a target molecule the detection reagent is intended to detect. Irradiating the inactive detection reagent by applying heat or other energy to disc 100, or a portion of disc 100, may release the protective photogroup, thus activating the reagent, and allowing the reagent to react with the sample and, if present, the target molecule. The activation step, e.g., irradiation of disc 100, may occur prior to introduction of the sample, during introduction of the sample, and/or after introduction of the sample into the chamber in which the inactivated reagent is stored. Application of heat to disc 100 is described further below.

In some aspects, after the initial incubation with the capture reagent(s), the sample may be transferred into a second reaction chamber, which may be pre-loaded with reagents for the detection of the analyte. In some embodiments the detection reagent(s) and the sample may be introduced into the secondary incubation chambers at the same time or in succession, one after the other.

Any suitable capture reagents and/or detection reagents may be used. For example, in some embodiments, the capture reagent(s) may comprise an antibody specific for an antigen present in the sample, and the detection reagent(s) may comprise a secondary antibody coupled to a detection tag (e.g., a fluorescent tag, a luminescent tag, and/or an enzyme tag, which may trigger a cascade detection signal). In some embodiments, the capture reagent(s) may comprise an antigen that binds specifically to an antibody present in the sample, and the detection reagent(s) may comprise a human specific antibody coupled to a detection tag (e.g., a fluorescent tag, a luminescent tag, and/or an enzyme tag, which may trigger a cascade detection signal). Alternatively or additionally, the capture reagent(s) may comprise nucleotide primers that trigger the amplification of a sequence of a genomic sample or miRNAs present in the sample, and the detection reagent may comprise a fluorescent intercalating molecule, for example, or a short oligonucleotide sequence coupled to a detection tag (e.g., a fluorescent tag, a luminescent tag, and/or an enzyme tag, which may trigger a cascade detection signal). These exemplary reagents may also be used in discs 200, 300, and 400, described in detail below.

The upper separation chamber 107, separation chamber 108, and detection chamber 110 (which may comprise the end of the microfluidic channel pathway) may provide for collection of the bound or captured targets or analytes. For example, when the capture reagents comprise microbeads to form capture molecule-microbead/target complexes, the upper separation, separation, and detection chambers 107, 108, 110 may provide for collection of the complexes and detection of the target(s). For example, the upper sedimentation chamber may be configured to funnel the sample down to the separation chamber 108. In some aspects, upper separation chamber 107 may have a tapered shape in order to promote funneling of the chamber contents into separation chamber 108. Separation chamber 108 may comprise a density medium, e.g., having a density less than that of the microbeads and greater than that of unbound reagents. Density media suitable for the microfluidic discs herein include, but are not limited to, Ficoll. After reaction with the sample, microbeads may be moved through the density medium in the separation chamber 108 to separate them from other reagents and to allow the collection of the beads as a pellet in the detection chamber 110. The pellet then may be analyzed by a detector to determine and analyze the presence and/or concentration of targets. The shapes of the separation chamber 108 and the detection chamber 110 may be designed to facilitate passage of the microbeads through the density medium and collection of the microbeads at the end of the channel. For example, the detection chamber 110 may have a generally tapered, V-shaped base, as shown in FIG. 1, or any other suitable shape. In some embodiments, disc 100 may be rotated so as to promote pellet formation. For example, disc 100 (or any of discs 200, 300, and 400, described below) may be rotated at a speed of approximately 3,000 RPM to approximately 5,000 RPM to promote pellet formation when the sample enters, or is contained in, the upper separation chamber 107, separation chamber 108, and/or detection chamber 110. The reaction, separation, and detection chambers of discs 200, 300, and 400, may operate similarly to those of disc 100 in FIG. 1.

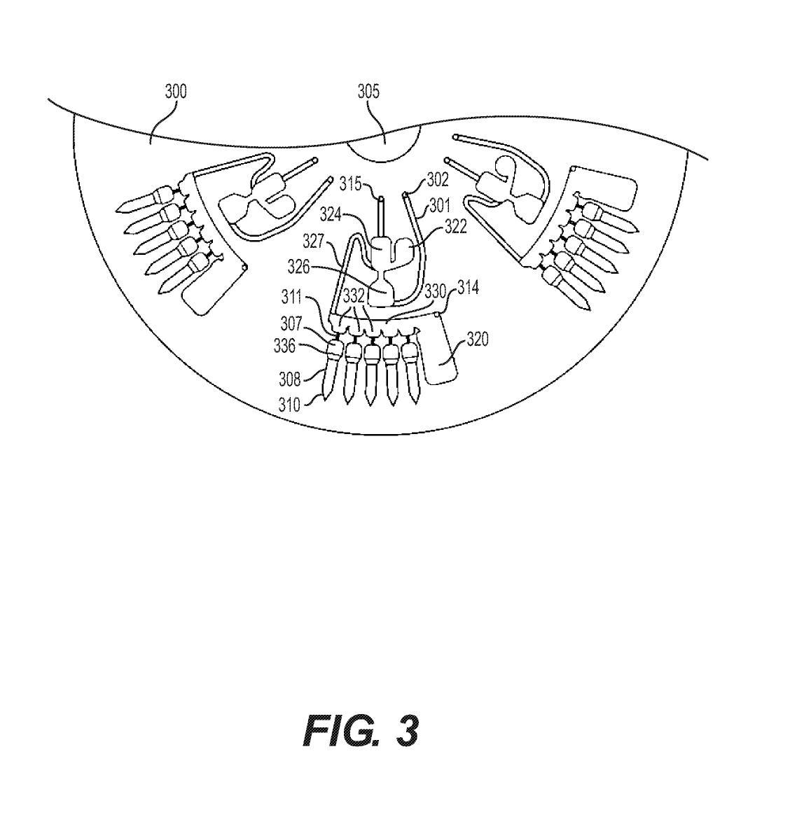

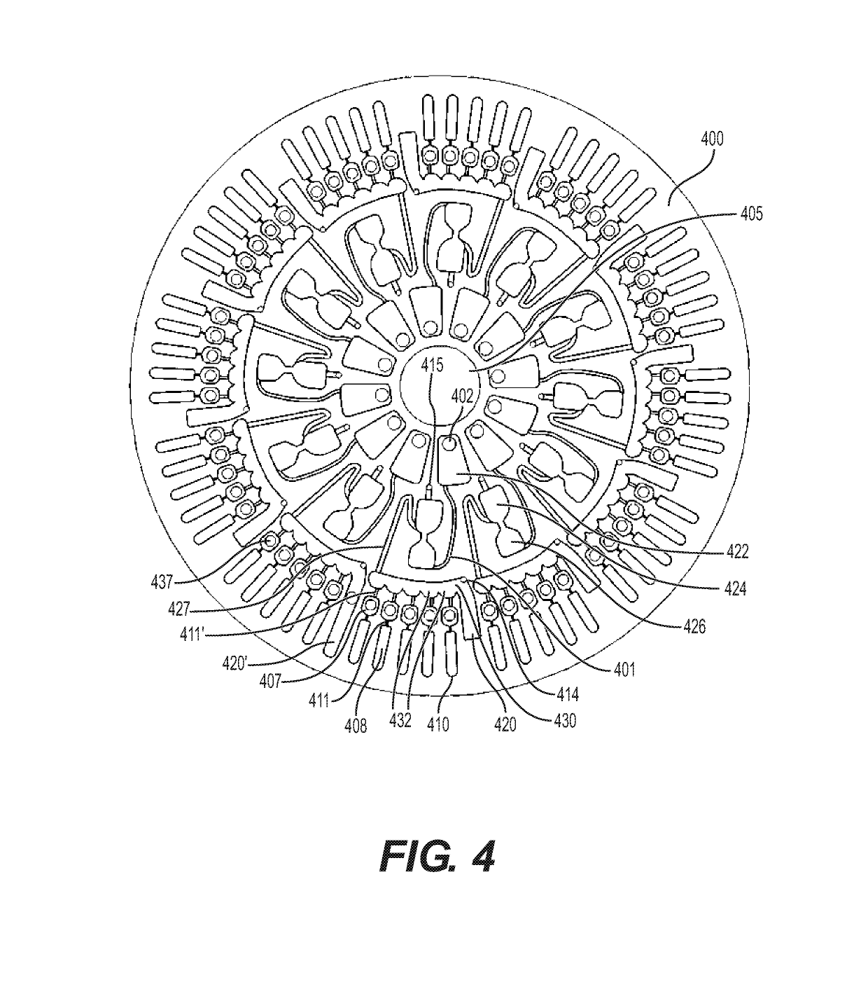

In some aspects of the present disclosure, e.g., when a microarray is used as the substrate for capture molecules rather than microbeads, the disc 100 may include an array chamber in place of the upper separation chamber 107, separation chamber 108, and detection chamber 110 shown in FIG. 1. The array chamber may have any suitable shape (including, e.g., a substantially rectangular shape, similar to the dimensions of the separation chamber 108, or a substantially square, circular, or other shape). The array chamber may contain, or serve as, the microarray substrate. For example, capture molecules may be attached to the surface of the array chamber for binding or hybridizing to analytes (e.g., biomarkers) present in the sample. As discussed above, the microarray may be designed for detection of one target (e.g., the microarray including capture molecules specific to a single analyte) or multiple, different analytes (e.g., the microarray including a set of capture molecules, each capture molecule being specific to a different analyte and defining a different feature of the microarray). It should be noted that, in some assays, the analytes to be detected may be bound or hybridized to capture molecules of a microarray without first reacting the sample with reagents. In such cases, the disc 100 may not include any reaction chambers 104, such that the sample inlet 102, the metering chamber 106, and/or one or more sample preparation chambers (such as, e.g., the plasma and/or sedimentation chambers discussed below in connection to FIGS. 3 and 4) may lead into the array chamber.

In some aspects, the array chamber may include detection molecules specific or complementary to the targets to assist in detection. The detection molecules may be combined with the analytes before or after the analytes are bound to the capture molecules of the microarray. Once the analytes have been bound to the capture molecules of the microarray, the array chamber may be washed with a buffer solution, e.g., to clear away any unbound or unreacted reagents. The buffer solution may be introduced by activating one or more reservoir chambers in communication with the array chamber. The reservoir chambers may be activated, for example, by spinning the disc 100 at a threshold speed to open valves (e.g., similar to valves 111 and 111′) between the array chamber and reservoir(s).

After washing, the microarray may be scanned or imaged with a detector to analyze the captures analytes. Such analysis may include identification and/or quantification of one or more query positions (e.g., target nucleotide sequence) in the analytes. For example, analytes bound to features of a microarray in the array chamber may be imaged with a CCD camera to detect and measure the relative intensity of each feature of the microarray. The position of each feature may be associated with a specific capture molecule (e.g., an aptamer or oligonucleotide with known nucleic acid sequence, or an antibody, among other suitable capture molecules), such that the positions of the features may be used to identify the analytes detected. In some examples, the intensity of each feature may be used to determine the concentration of the analyte in the sample (e.g., based on a known relationship or correlation of intensity to an analyte concentration). The detection may be performed in a single color mode or a dual color mode. A dual color mode may be useful, for example, in a comparative study to determine a relative copy number of genes, or an overexpression or under expression of specific genes or proteins in a control sample (e.g., healthy patient) as compared to an unknown sample.

While disc 100 as shown includes eight fluid channel pathways, it is recognized that disc 100 may include any suitable number of channel pathways. For example, individual channel pathways may be arranged closer together or farther apart from one another on disc 100. The number of channel pathways included on a given disc 100 may depend, at least in part, on the number of assays to be run on disc 100 or the intended use of disc 100. In some aspects, a different sample may be tested in each pathway, and increasing the number of pathways may increase the number of samples that may be assayed at once. Each channel pathway may include substantially the same types and sequence of chambers, or may include different types of chambers and/or a different sequence of chambers. For example, the disc 100 may include a first channel pathway comprising a reaction chamber 104 in fluid connection with a separation chamber 108 and a detection chamber 110, and a second channel pathway comprising a reaction chamber 104 in fluid connection with an array chamber.

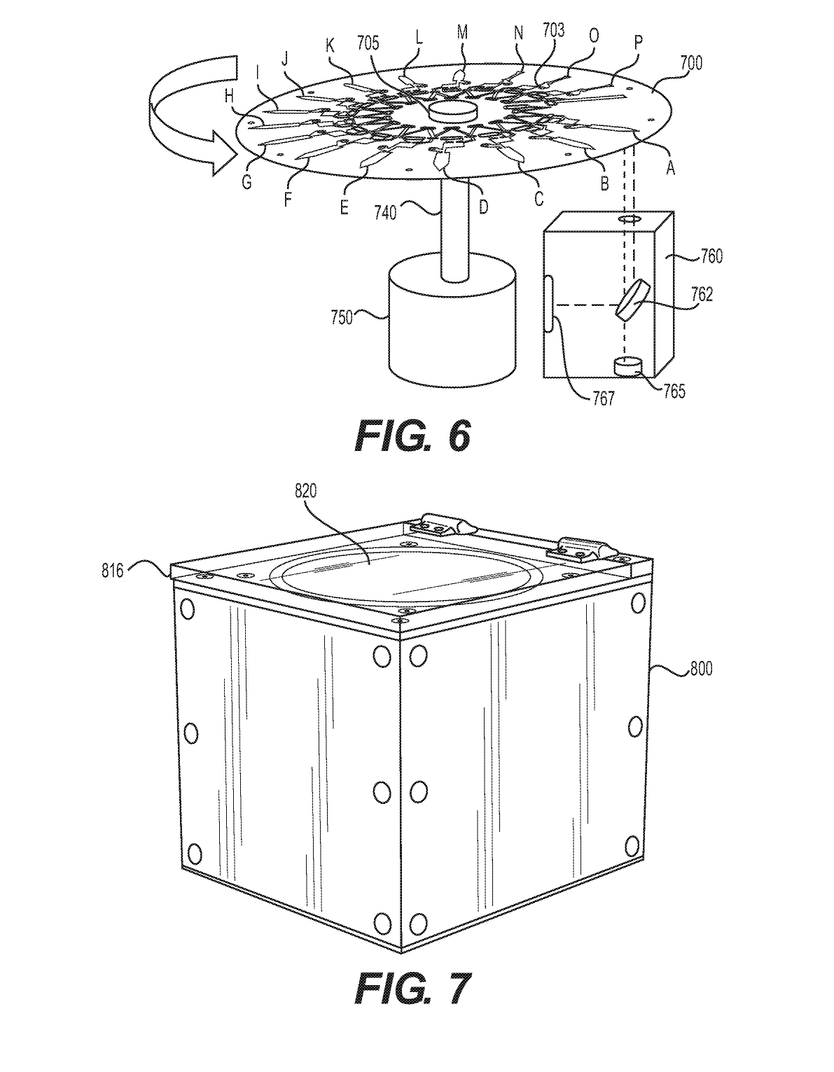

In some aspects, the device may be configured to heat certain chambers of a microfluidic disc at a predetermined temperature or temperature gradient, such as during an amplification reaction or other type of reaction. For example, the device (see, e.g., FIGS. 6 and 7 discussed below) may include one or more heating elements in close proximity of disc 100 (or any of discs 100, 300, or 400, discussed below), e.g., above and/or below the disc 100. The position of the heating elements may correspond to the location(s) of the chamber(s) of the disc 100 to be heated, such that the heating is localized to the desired chamber(s). In some examples, the chambers may be designed such that only some of the chambers (e.g., having the same radial distance) will be heated by the heating elements, whereas other chambers will not be heated. In some aspects of the present disclosure, portions of the microfluidic disc may comprise an insulating material or heat transfer material to facilitate localized heating of chambers.

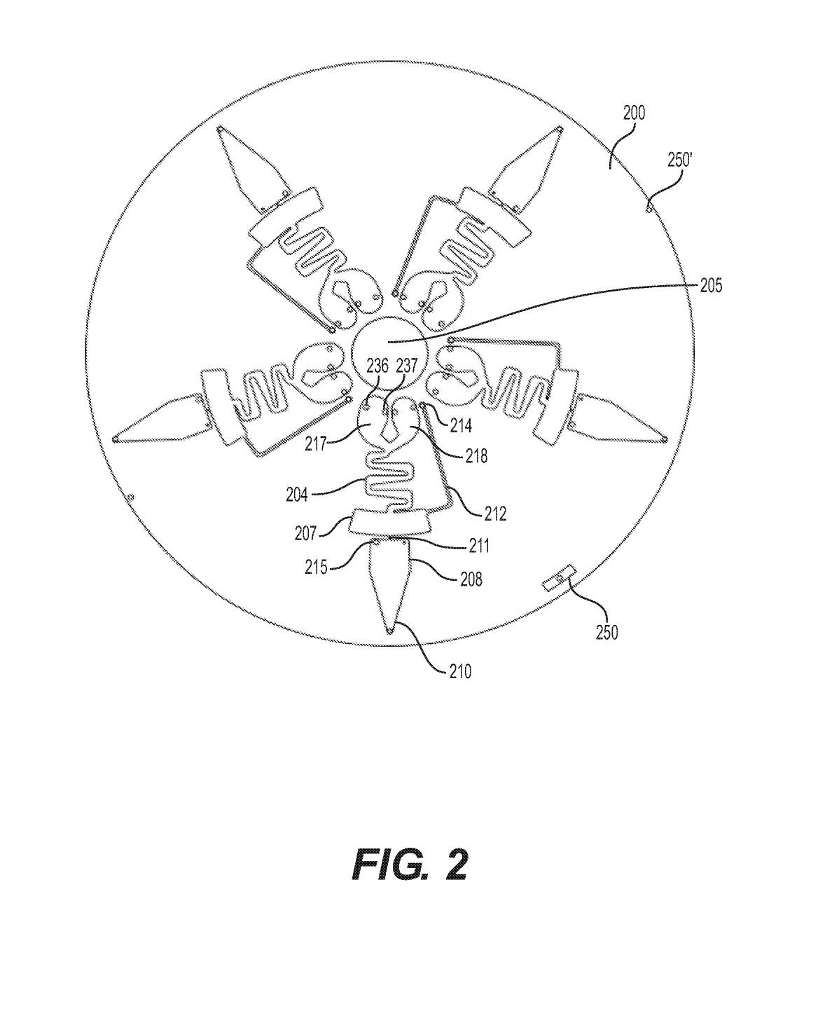

FIG. 2 shows an exemplary disc 200 comprising a plurality of microfluidic channel pathways, according to some aspects of the present disclosure. The channels pathways of disc 200 may extend radially outward at regularly spaced intervals. Each channel pathway may include a valve 211, which may be a burst valve, as described in FIG. 1. The microfluidic disc 200 may include a central aperture 205 similar to aperture 105 of disc 100 in FIG. 1. The disc 200 also may include a marker 250 and/or a marker 250′ to assist in determining the location of various channel pathways relative to each other, e.g., for associating each channel with a particular analyte of interest during detection.

Each channel pathway may include, or be in communication with, one or more sample inlets 236, one or more vents 237, component chambers 217 and 218, mixing chamber 204, incubation chamber 207, vent channel 212, vent hole 214, separation chamber 208, vent 215, and detection chamber 210. During operation, a portion of sample may be introduced into an inlet 236 located in each of component chamber 217 and component chamber 218. Component chambers 217, 218 may each house a reagent or combination of reagents configured to mix with the sample. In some aspects, each component chamber 217, 218 may include the same type of reagent(s). For example, dividing the reagent(s) between two separate chambers may allow the full volume of sample to mix more completely with the reagent. In some aspects, component chambers 217, 218 may each house a different reagent or combination of reagents. This may allow for step-wise introduction of different reagents. For example, the different reagents may mix with aliquots of a sample introduced into the respective chambers 217, 218 separately, before being combined together into mixing chamber 204. In some examples, component chambers 217, 218 may each include a vent 237 to equalize pressure as sample is introduced into the chambers and/or to allow for the escape of gaseous byproducts as the sample is mixed with the reagent(s).

The sample may then flow from component chambers 217, 218 to mixing chamber 204. Mixing chamber 204 (which may in some embodiments may be a mixing channel) may be shaped to promote mixing of the sample as it enters and passes through. As described in reference to FIG. 1, one or more channels or chambers may be oriented in a radially or azimuthal zig-zag pattern to promote mixing of the sample with the reagent(s). In FIG. 2, the mixing chamber 204 may include one or more portions that are oriented substantially perpendicular to the flow of fluid from the inlet 236 to the detection chamber 210. In some aspects, the cross-section of the mixing chamber 204 (or mixing channel) may vary, e.g., alternating from larger to smaller, which may create a focusing and defocusing cycle to further promote mixing. The walls of a chamber and/or a channel may include features, such as physical structures, to incubate and mix the sample and reagent(s). The walls of mixing chamber 204 define a serpentine path. Additionally or alternatively, the walls may include one or more angles, projections, or recesses to agitate or otherwise affect the flow of fluid to encourage mixing.

The mixing chamber 204 may empty into an incubation chamber 207. The sample may be retained within incubation chamber 207 for a predetermined amount of time to prepare the sample. A valve 211, like valve 111 of FIG. 1, may keep the sample within incubation chamber 207 until disc 200 is rotated above a certain, threshold speed. Incubation chamber 207 may be fluidly connected to a vent channel 212 and a vent hole 214, which may operate similarly to other vents described herein.

In some aspects, incubation chamber 207 may function similarly to reaction chamber 104, described above, in that incubation chamber 207 may also contain reagents that mix with the sample as the sample enters. In this aspect, incubation chamber 207 may also allow for step-wise introduction of a sample with reagent(s). , For example, one or more reagents may be mixed with the sample in component chambers 217, 218, and additional reagent(s) may be mixed with the sample in incubation chamber 207.

Sample may then flow from incubation chamber 207 into separation chamber 208 and into detection chamber 210. One or both of separation chamber 208 and detection chamber 210 may include a vent 215 configured to equalize pressure as the respective chambers fill with fluid and/or to vent by-products produced by reaction with reagents. Separation chamber 208 and detection chamber 210 may be similar to separation chamber 108 and detection chamber 110 described above in reference to disc 100. In some aspects, the disc 200 may include an array chamber, e.g., in place of separation chamber 208 and detection chamber 210 as discussed above in connection to FIG. 1.

While disc 200, as shown, includes five fluid channel pathways, it is recognized that disc 200 may include any suitable number of channel pathways. For example, individual channel pathways may be arranged closer together or farther apart from one another on disc 200. The number of channel pathways included on a given disc 200 may depend, at least in part, on the number of assays to be run on disc 200 or the intended use of disc 200. In some aspects, a different sample may be tested in each pathway, and increasing the number of pathways may increase the number of samples that may be assayed at once.

FIG. 3 shows a portion of another exemplary microfluidic disc 300. Each channel pathway of disc 300 includes a sample inlet 302, an inlet channel 301, a sedimentation chamber 326, a compression chamber 322, a plasma chamber 324, an outlet channel 327, a main channel 330, a waste chamber 320, a plurality of metering chambers 332, a plurality of reaction chambers 307, a plurality of separation chambers 308, and a plurality of detection chambers 310. Like discs 100 and 200, microfluidic disc 300 may also include a central aperture 305, one or more valves 311, and one or more vents 314, 315, which may operate similarly to the equivalent components included on discs 100 and 200 of FIGS. 1 and 2.

On disc 300, the transport of fluid from a given fluid-containing chamber and/or channel to other chambers and/or channels downstream may be achieved with the assistance of the compression chamber 322. A sample may be introduced into sample inlet 302 and may travel radially outward through inlet channel 301. The inlet channel 301 may empty into radially outward sedimentation chamber 326, which may be fluidly connected to the plasma chamber 324, positioned radially inward relative to sedimentation chamber 326. As the sample is introduced, air or other gas(es) present in the disc may be trapped in compression chamber 322. The compression chamber 322 may be adjacent to, and at substantially the same radial position as, the plasma chamber 324. Plasma chamber 324 may be connected to the compression chamber 322 by an azimuthal fluidic connection, and the azimuthal fluidic connection may be at substantially the same azimuthal position as outlet channel 327 exiting plasma chamber 324. The outlet channel 327 may have a radially inward curve followed by a radially outward curve.

When the disc 300 is rotated at a first speed, the fluid in plasma chamber 324 may not be able to move along the radially inward curve of the outlet channel 327 due to centrifugal forces. For example, the first rotational speed may be sufficient for the fluid to collect in the sedimentation chamber 326 and/or the plasma chamber 324, but too great for the fluid to move past the radially-inward curve of the outlet channel 327. As a result, the fluid in the plasma chamber 324 may push against air or other gas(es) present in the compression chamber 322 and may compress the gas(es). When the disc 300 is slowed down to a second rotational speed, or stopped, the compressed gas(es) in compression chamber 322 may expand, pushing the fluid past the inward curve of the outlet channel 327, allowing centrifugal forces to siphon the fluid contained within plasma chamber 324 along the outlet channel 327 and into the downstream chambers and/or channels.

In certain aspects, the separation of plasma from a blood sample may be achieved, with the assistance of a compression chamber 322. For example, two chambers at radially different positions (e.g., radially inward and radially outward) may be fluidly connected to each other. A blood sample may be introduced into one chamber of the pair of chambers located at radially different positions on the disc.

On disc 300 of FIG. 3, for example, sedimentation chamber 326 is the radially outward chamber, and plasma chamber 324 is the radially inward chamber. The disc 300 may be rotated in a predetermined manner (e.g., at a predetermined speed) to collect red blood cells and other blood components heavier than plasma in the radially outward sedimentation chamber 326 and to localize the lighter weight plasma in the radially inward plasma chamber 324. In this manner, heavier blood components may be separated from lighter blood components. The first rotational speed sufficient to induce separation of the blood may range, for example, from about 500 RPM to about 10,000 RPM, e.g., from about 500 RPM to about 5,000 RPMs, or from about 3,000 RPM to about 7,000 RPM.

Plasma from the radially inward plasma chamber 324 may be transported to downstream chambers and/or channels with the assistance of the compression chamber 322. The compression chamber 322 may be adjacent to, and at substantially the same radial position as, the plasma chamber 324, and may be connected to the plasma chamber 324 by means of an azimuthal fluidic connection at the same azimuthal position as outlet channel 327 leading from the plasma chamber 324. The outlet channel 327 may have a radially inward curve followed by a radially outward curve, as described above. When the disc is rotated at speeds sufficient to separate plasma from blood, fluid may be prevented from moving past the radial inward curve of the outlet channel 327 due to centrifugal forces. The liquid may, for example, push against air or other gas(es) in the compression chamber 322 and compress the gas(es). When the disc is slowed down to a second speed or stopped, the compressed gas(es) may expand, pushing the liquid in the radially inward plasma chamber 324 past the inward curve of the outlet channel 327. The second, slower speed may be any speed slower than the initial speed used to separate the blood components. In some aspects, the second speed may include bringing disc 300 to a complete stop. Centrifugal forces then may siphon the liquid from the radially inward plasma chamber 324 into one or more downstream channels and/or chambers. Heavier blood components collected in sedimentation chamber 326 may remain in the sedimentation chamber 326 and may not exit outlet channel 327, and, as a result, may effectively be removed from the sample. The remainder of the assays may then be performed on the plasma, as opposed to whole blood.

Although certain features of disc 300 are discussed in the context of analysis of a blood sample, e.g., including reference to chamber 324 as a “plasma” chamber 324, and the separation of blood plasma from other heavier blood components, it will be understood that any suitable fluid may be contained within plasma chamber 324, and any suitable sample may be separated into heavier and lighter components. Disc 300 is not limited to use with a blood sample. Thus, for example, plasma chamber 324 may be used to separate out heavier components from any other biological fluid during an assay.

In some aspects, the separation of plasma may be achieved, for example, through use of capillary forces and/or the application of pressure to the plasma (or other separated component of a sample) to force it to move to certain areas of the disc. The disc may be rotated to push plasma in a given direction, e.g., through a particular channel or chamber, by means of centrifugal forces. In some aspects, disc 300 (or any of discs 100, 200, or 400) may include one or more filters or filtering materials, for example, a porous membrane, resin, or cross-linked gel such as Sephadex. For example, the filter(s) may be located between a blood input chamber (e.g., plasma chamber 324) and an outlet channel or hole(s) (e.g., outlet channel 327). The pore size of the filter(s) may only allow passage of a sample, e.g., plasma, and may substantially prevent passage of larger materials into outlet channel 327. Additionally or alternatively, one or more filters may be located between sedimentation chamber 326 and plasma chamber 324, or at one or both ends of sample inlet 302 and sample inlet channel 301, for example. Exemplary discs in accordance with the present disclosure may include filter(s) fit within a sample inlet of the disc so as to allow the separated plasma to enter the channel segment and undergo analysis.

The filter(s) or filtering material may be used to selectively remove unwanted material, e.g., debris or unwanted components, such as small molecules, oligonucleotides, proteins, or cells present in the sample from subsequent analysis of the sample during an assay. In some embodiments, the filter(s) or filtering material may be partially or completely coated, e.g., to improve its affinity toward specific components to be removed from the sample, such as, e.g., small molecules, oligonucleotides, proteins, or cells present in the sample. Exemplary coatings may be hydrophilic, hydrophobic, or amphiphilic. Suitable coatings include, e.g., natural and synthetic materials, such as functionalized silanes, polymers, polyamines, polystyrenes, graphenes, polysaccharides, polyethyleneglycols, small molecules, solutions, or salts. In some aspects, suitable coatings may have anticoagulant properties, such as EDTA or Heparin, for example.

Fluid travelling through outlet channel 327 may be moved into a metering section (comprising metering chambers 332), e.g., to apportion the appropriate volume of aliquot for subsequent steps of the workflow (see, e.g., FIG. 3). The separated sample component (e.g., plasma component) may flow from outlet channel 327 to main channel 330 of metering chambers 332.

As shown in FIG. 3, the number of reaction chambers 307, separation chambers 308, and detection chambers 310 (for detection of a target) may be greater than the number of sample inlets 302. As shown, for example, the disc 300 includes five reaction chambers 307, five separation chambers 308, and five detection chambers 310 (collectively, incubation chambers) for each sample inlet 302.

The sample may be divided into a plurality of parallel paths (e.g., five in disc 300), and, in some aspects, each parallel path may be configured to capture a single type of analyte, e.g., a single biomarker, so that each path in a channel pathway is representative of a different biomarker. In other aspects, each parallel path may be representative of the same biomarker, or some may be the same while others are different. Beads comprising capture molecules specific to each respective biomarker stored in each parallel path may be analyzed substantially simultaneously, or, in some embodiments, sequentially. The order of analysis may depend on when the sample is aliquoted into each path (e.g., simultaneously or sequentially).

While FIG. 3 illustrates five parallel reaction chambers 307, which empty into respective separation chambers 308 and detection chambers 310, any suitable number of parallel reaction chambers may be used. For example, a channel pathway may include a sequence from 1 to 100 reaction chambers, such as from one to twenty chambers, from one to ten chambers, e.g., 2, 3, 4, 5, 6, 7, 8, 9, 10, 15, or 20 chambers in sequence.

The number of parallel reaction chambers in a given channel pathway may, in some aspects, be determined based on the number of different biomarkers measured in an assay. As an example, disc 300 may be configured for use with an assay that detects 5 different biomarkers, and thus each channel pathway may include 5 reaction chambers 307 in parallel. By including the reaction chambers 307 in parallel, disc 300 may allow for detection of 5 different biomarkers substantially simultaneously, or, in some aspects, sequentially, in a given channel pathway. In some aspects, the same biomarkers may be measured in each reaction chamber 307 in a given pathway, but each reaction chamber 307 may contain different reagents or combinations of reagents. In such aspects, the disc 300 may allow a sample to be tested for the same biomarker using 5 different reagents or combinations of reagents, one in each reaction chamber 307.

The chamber and channel circuitry of a given disc may be arranged to allow measurement of multiple biomarkers for multiple samples, or, conversely, to measure multiple biomarkers for a single sample. The arrangement of the reaction chambers, separation chambers, and detection chambers (or, when a microarray is used, array chamber) may impact the number of biomarkers to be detected. For example, an assay may screen for 2-20 biomarkers, e.g., 15 biomarkers associated with a disease. Thus, each channel pathway may include, e.g., 15 reaction chambers, one for each biomarker to be detected. A sample introduced into a given channel pathway may then be divided among the 15 reaction chambers as the sample flows through the chambers and/or channels of the pathway.

Multiple channel pathways may then be arranged on a disc, each extending radially out from a center region of the disc. The number of channel pathways included on a disc may depend, at least in part, on the size of the disc and/or the number of reaction chambers arranged in parallel in a given channel pathway. For example, for an exemplary assay used for general cancer screening, the disc may include between 1 and 10 channel pathways, such as, for example, between 3 and 7 pathways. Thus, for example, if 4 pathways are included on a single disc, the disc may include a total of 60 individual reaction chambers, e.g., for testing of up to 4 different samples (e.g., one sample in each channel pathway).

In another example, a breast cancer panel may include detection and/or measurement of 5 single biomarkers, such that each channel pathway on a disc may include a chamber and/or channel (e.g., a metering chamber) that aliquots a single sample input into each of 5 reaction chambers. The number of channel pathways included on a disc may depend, at least in part, on the size of the disc. Disc 300, for example, may include between 1 and 20 channel pathways or more, e.g., between 10 and 15 channel pathways. For example, if 12 channel pathways are included on disc 300, each with 5 detection chambers, disc 300 would include a total of 60 individual reaction chambers, e.g., and may be capable of testing up to 12 samples.

One or more metering chambers 332 may be arranged in a substantially perpendicular direction with respect to outlet channel 327 and reaction chambers 307, separation chambers 308, and detection chambers 310. Each metering chamber 332 leads into a reaction chamber 307 (e.g., where, in some examples, reagents such as capture molecules and/or microbeads may be pre-loaded into the disc 300), a separation chamber 308 (where, in some examples, density media may be pre-loaded), and a detection chamber 310 (where, in some examples, reagents such as detection reagents may be pre-loaded into the disc 300). The sample may flow out of outlet channel 327 and into main channel 330. As the fluid flows along the main channel 330, the metering chambers 332 may fill with fluid. As metering chambers 332 become filled, excess fluid may flow from the main channel 330 and ultimately, into waste chamber 320. One or more vents 314 may be located in main channel 330 and/or waste chamber 320.

The number of metering chambers 332 may be determined according to the number of analytes (e.g., biomarkers) to analyze. For example, the total number of metering chambers of a given disc may range from 1 to 1,000, such as from 1 to 500, from 1 to 200, from 1 to 100, from 1 to 60, from 1 to 50, from 1 to 20, from 1 to 12, or from 1 to 6. Each metering chamber 332 may have the same aliquoting volume, or different metering chambers 332 may have different aliquoting volumes, depending on the device parameters suitable for analyzing the specific biomarkers present in a sample or sample panel. Exemplary aliquoting volumes may range from about 1 nanoliter to one or more milliliters, such as from about 0.1 microliters to about 100 microliters.

In some embodiments, a valve 311 may be located between each metering chamber 332 and a respective reaction chamber 307, which may also act as an incubation chamber. Each reaction chamber 307 may be pre-loaded with one or more reagents for detecting an analyte of interest, as described above in reference to discs 100 and 200. In some aspects, different reaction chambers 307 may be pre-loaded with the same reagents in each or with different reagents in each. The valves 311 may be activated by centrifugal force (e.g., each valve 311 may be a burst valve, as described in reference to FIG. 1) or other suitable mechanisms of activation. Upon activation of the valves 311 (e.g., rotation of disc 100 above a threshold speed), the aliquoted volume of sample fluid in a given metering chamber 332 may enter into a respective reaction chamber 307. In some aspects, one or more reaction chambers 307 may include a ledge 336 in a lower region of the reaction chamber 307, which may include a second valve. The valve at ledge 336 may prevent the sample from flowing out of reaction chamber 307 and into separation chamber 308 until disc 100 is rotated at a predetermined rotational speed (for example, from approximately 1,000 RPM to approximately 5,000 RPM, e.g., from approximately 2,000 RPM to approximately 3,000 RPM). The contents of reaction chamber 307, including, e.g., sample, microbeads, etc., may be prevented from passing out of reaction chamber 307 and into separation chamber 308 until the valve at ledge 336 is opened. As discussed previously, the rotational speed required to open valve 311 may be less than the rotational speed required to open the valve at ledge 336. In some aspects, the reagents and the aliquoted (metered) sample may be introduced into the separation chambers 108 at substantially the same time or sequentially, one after the other. For example, individual valves 311 may be configured to open at different threshold speeds. In such arrangements, rotating the disc 300 at one speed may open up a first valve 311, then rotating the disc 300 at a faster speed may open up a second valve 311, thus staggering the release of sample from reaction chambers 307 into separation chambers 308. The difference in the threshold speeds of the individual valves relative to each other may be relatively small. During this portion of the assay, the disc 300 may be rotated at a gradually faster speed to cause the staggered release of the valves 311.

Each channel pathway following the metering chambers 332 may have a specific pattern, e.g., following a path for reaction with a specific reagent or set of reagents depending on the analyze to be captured and detected. In some embodiments, for example, at least one of the channel pathways following a metering chamber 332 may include two or more reaction chambers 307 arranged in sequence. For example, a process according to the present disclosure may include an incubation step in which the sample is treated with reagents in multiple reaction chambers in sequence.

Sample containing reacted and unreacted reagents may flow from reaction chambers 307 into separation chambers 308 (as may occur in chambers 108 or 208 discussed above) to separate analytes (e.g., captured analytes) from the unbound reagents and/or to concentrate the analytes in a subsequent chamber, such as the detection chamber 310. In some aspects, the captured analytes may be separated by physical means. For example, the reagents may include bead-immobilized capture reagents, which may have a different density than the solution comprising the sample and unreacted detection reagents, as well as other components, such as buffers and/or surfactants. A plurality of microbeads may have capture molecules covalently attached to the surface so that a binding site at the free end of each capture molecule is available for binding with a target of the sample. The separation of captured analytes may be effected by rotating the disc to subject the captured analytes and the other components of the solution to centrifugal forces.

In some aspects, the separation chambers 308 (or chambers 108 or 208 discussed above) may be pre-loaded with a sedimentation solution or wash buffer of known density to facilitate the separation of the captured analytes from the rest of the reagents. Such sedimentation solution or wash buffer may have a density that is intermediate between the density of the bead-immobilized capture reagent and the density of the rest of the reagents. Upon application of centrifugal force (e.g., via rotation of the disc), the bead immobilized capture reagents may compact within the separation chamber 308, e.g., forming a pellet. The volume of the pellet formed may be based, at least in part, on the size and number of the beads and the centrifugal force applied. For example, disc 300 may be rotated at a speed of approximately 3,000 RPM to approximately 5,000 RPM to promote pellet formation.

In some embodiments, each separation chamber 308 (or chambers 108 or 208 discussed above) may serve to closely pack the bead immobilized capture reagents (which may be used to generate signal indicative of analytes captured by, and coupled to, the beads) by narrowing in shape as it extends radially outwards to form the detection chamber 310. Detection chamber 310 may thus be dimensioned to contain the closely-packed beads. The shape of the detection chamber(s) 310 may be selected based on the characteristics of the pellet to be generated by the sedimentation process. For example, the size of the detection chamber(s) 310 may be dependent upon the total number of capture immobilized beads used for a specific analyte. In the embodiment of FIG. 3, each detection chamber 310 may be of the same size and/or shape relative to the other detection chambers 310, or each detection chamber 310 may not be of the same size and/or shape. For example, the disc 300 may include at least one detection chamber 310 having a different size and/or different shape than at least one other detection chamber 310. The dimensions of the detection chamber 310 may be selected at least in part based on the nature of the analyte(s) to be detected and/or the capture reagent(s) used to capture the analyte for detection.

In some aspects, the detection chamber(s) 310 (or chambers 110 or 210 discussed above) may have a total volume between about 1 nanoliter and about 1 milliliter, such as between about 10 nanoliters and about 1 microliter. The dimensions (e.g., depth, length in a radially outward direction, width from side to side, and cross-sectional area) of the detection chamber(s) 310 may be the same or different than the dimensions of the sedimentation chamber(s) 308. In some aspects, the depth of the detection chamber(s) 310 may be between about 0.1 micron and about 10 millimeters, such as between about 0.1 micron and about 100 microns. As used herein, “between” in the context of a range encompasses both the first and last numbers in the range.

Detection of the analyte or analytes may be performed by any suitable technique, including radioactive, electrical, or optical means, such as, e.g., fluorescence, phosphorescence, luminescence, chemiluminescence, or absorbance, among other techniques.

In some embodiments, the detection chamber(s) 310 (or detection chambers 110 or 210 discussed above) may include a coating. For example, the detection chambers 310 may be coated with a small molecule and/or a polymeric material, e.g., to improve the detection of the analyte(s), such as by amplifying the signal or by reducing background noise. Exemplary coatings may be hydrophilic, hydrophobic, or amphiphilic. Suitable coatings include, e.g., natural and synthetic materials, such as functionalized silanes, polymers, polyamines, polystyrenes, graphenes, polysaccharides, polyethyleneglycols, small molecules, solutions, or salts. In some aspects, suitable coatings may have anticoagulant properties, such as EDTA or Heparin, for example. In one aspect, one or more surfaces of the detection chamber(s) 310 may include, e.g., small molecules, oligonucleotides, proteins, and/or polymeric structures immobilized thereon to amplify the signal or reduce background noise.

In some aspects, the disc 300 (or discs 100, 200, or 400) may include a component configured to mask a signal (e.g., optical, radioactive, or electrical) coming from a portion of the disc 300 other than the detection chamber 310. For example, portions of the disc 300 other than the detection chambers 310 may include a coating to render them opaque. Opaque materials, such as black plastics, may be used to form portions of the disc during fabrication, or coatings, e.g., black-colored coatings, may be applied to a transparent disc during fabrication. In some aspects, a disc may be formed of transparent material, and one side of the transparent material may be coated with a light-refractive material to increase the efficiency of light excitation during the detection step by promoting light reflection. Additionally or alternatively, for a disc 300 made of transparent material, a layer opaque to the radiation or signal used may be bonded to the disc, and an opening may be left at a location that corresponds to the location of the detection chamber(s) 310. In some embodiments, the disc may be made of an opaque material or materials, and an inlay of transparent material or materials may be applied at the location of the detection chambers 310. In some aspects, the disc 300 may include an array chamber, e.g., in place of separation chamber 308 and detection chamber 310 as discussed above in connection to FIG. 1.

As mentioned above in connection to FIGS. 1 and 2, the microfluidic discs herein may include one or more features to assist in determining the identify and/or location of particular microfluidic pathways relative to others. In certain aspects, any of discs 100, 200, 300, or 400 may include one or more markers or marker regions, which can be used for orientation purposes. For example, the marker regions may be used to position the detector region, measure the speed of rotation of the disc, and/or measure the relative position of optical signal generating regions on the disc while the disc is rotating. The marker regions may include changes in texture, color, reflectivity, or other suitable characteristics to distinguish them from the rest of the disc. In some aspects, marker regions may include recesses, grooves, projections, or other changes in shape from the surrounding portions of the disc. Marker regions may be located on an upper surface, a bottom surface, or a side surface, or may be embedded within a surface of the disc. The marker regions may or may not be perceivable to a human user and may or may not be readable by a component of the microfluidic system.

Disc 400, shown in FIG. 4, may operate in a substantially similar manner to that of disc 300, except that disc 400 may not include a compression chamber. By not including a compression chamber, disc 400 may reduce the amount of space each channel pathway takes up on the disc, which may, in some aspects, allow disc 400 to be more compact or may increase the number of assays and/or samples that may be run on a single disc 400. In some aspects, reducing the number of channels and/or chambers may also reduce the cost of disc fabrication. In some instances, however, it may be beneficial to include a compression chamber. For example, a compression chamber may improve disc function for assays in which a more vigorous force is needed to move the fluid along a channel pathway. In some aspects, a compression chamber may be positioned adjacent a reaction chamber and/or a mixing chamber to promote mixing of the sample.

The flow of sample through disc 400 may be achieved via rotation of the disc and capillary force. A sample may enter sample inlet 402, flow into sample inlet chamber 422, and into inlet channel 401. Inlet channel 401 may empty into radially outward sedimentation chamber 426, which may be fluidly connected to plasma chamber 424. Plasma chamber 424 may be fluidly connected to a vent 415. The fluid connection between sedimentation chamber 426 and plasma chamber 424 may be narrower than either of the two chambers, so that sedimentation chamber 426 and plasma chamber 424 cooperatively form an hourglass-like shape. Like disc 300, an outlet channel 427 may fluidly connect to plasma chamber 424 and may have a radially inward curve followed by a radially outward curve. When the disc 400 is rotated at a first speed, the fluid in plasma chamber 424 may not be able to move past the radial inward curve of the outlet channel 427 due to centrifugal forces. When the disc 400 is slowed down to a second speed, the centrifugal forces may decrease, and the fluid may move past the inward curve of the outlet channel 427 and into the downstream chambers and/or channels via one or more of capillary action and centrifugal force.

As with disc 300, the inclusion of two chambers fluidly connected to each other and located at radially different positions (e.g., radially inward and radially outward) may allow cells and/or other heavier components of a sample to move radially outward and collect in the radially outward chamber while lighter components move radially inward and collect in the radially inward chamber in response to centrifugal forces. A sample, e.g., a blood sample, may be introduced into one chamber of the pair of chambers located at radially different positions on the disc.

On disc 400 of FIG. 4, for example, sedimentation chamber 426 is the radially outward chamber, and plasma chamber 424 is the radially inward chamber. The disc 400 may be rotated in a predetermined manner (e.g., at a predetermined speed) to collect red blood cells and other blood components heavier than plasma in the radially outward sedimentation chamber 426 and to localize the plasma in the radially inward plasma chamber 424. In this manner, heavier blood components may be separated from lighter blood components. Suitable rotational speeds for separating plasma from other blood components may range from approximately 500 RPM to approximately 10,000 RPM, e.g., from approximately 500 RPM to approximately 5,000 RPM, or from approximately 3,000 RPM to approximately 7,000 RPM.

In some aspects, plasma from the radially inward plasma chamber 424 may then be transported to downstream chambers. When the disc 400 is rotated at higher speeds sufficient to separate plasma from blood, fluid may be prevented from moving past the radial inward curve of the outlet channel 427 due to centrifugal forces. Rotating disc 400 at higher speeds may also compress the plasma (or other suitable sample) within plasma chamber 424. When the disc 400 is slowed down to a second, slower speed, the centrifugal force acting on the sample may be reduced, and the sample in the radially inward plasma chamber 424 may be able to flow past the inward curve of the outlet channel 427, e.g., via capillary action. Slowing disc 400 may also allow the plasma to expand within plasma chamber 424, promoting movement of the sample out of plasma chamber 424 and into the outlet channel 427. Exemplary slower speeds may include any suitable speed less than the first speed used for sample separation, including, e.g., bringing disc 400 to a complete stop. Centrifugal forces then may siphon the liquid from the radially inward plasma chamber 424 into one or more downstream channels and/or chambers. Heavier blood components collected in sedimentation chamber 426 may remain in the sedimentation chamber and may not exit outlet channel 427, and, as a result, may effectively be removed from the sample. In some aspects, outlet channel 427 may further include one or more valves, filter(s), filter materials, etc., to control the flow of fluid and/or prevent separated sample components in sedimentation chamber 426 from entering outlet channel 427. The remainder of the assays may then be performed on the plasma, as opposed to whole blood.

The separated sample (e.g., plasma sample) may flow from outlet channel 427 to main channel 430 of metering chambers 432. Excess fluid may flow to waste chamber 420, and aliquoted fluid may flow from metering chambers 432 into reaction chambers 407 (which may act as incubation chambers), separation chambers 408, and detection chambers 410. These components may operate substantially similarly to the corresponding components of disc 300, described in detail above. In some aspects, each separation chamber 408 and detection chamber 410 may be dimensioned to hold from approximately 1 μL to approximately 6 μL of fluid, e.g., approximately 5 μL of fluid.

Likewise, valves 411′ and 411 may operate similarly to valves 111′ and 111 described in reference to FIG. 1. For example, in one exemplary aspect, valves 411′, 411 may include burst valves. Rotation of disc 400 below a threshold rotational speed may prevent sample from flowing from metering chambers 432 to reaction chambers 407, while rotation above the threshold may provide enough centrifugal force to open the valve 411′, allowing the sample to flow between the chambers. Likewise, rotation of disc 400 below a threshold rotational speed may prevent sample from flowing from reaction chamber 407 to sedimentation chamber 408, while rotation above the threshold may provide enough centrifugal force to open the valve 411, allowing the sample to flow between the chambers. In some aspects, the amount of force required to open the valve 411′ between metering chambers 432 and reaction chambers 407 may be less than the amount of force required to open valve 411 between reaction chambers 407 and sedimentation chamber 408. Phrased differently, it may take a lower threshold rotational speed to open valve 411′ than to open valve 411. For example, valve 411′ may open in response to rotation above a threshold of approximately 1,000 RPM to approximately 2,000 RPM, while valve 411 may open in response to rotation above a threshold of approximately 1,500 RPM to approximately 3,000 RPM.

While disc 400 as shown includes twelve fluid channel pathways, it is recognized that disc 400 may include any suitable number of channel pathways. For example, individual channel pathways may be arranged closer together or farther apart from one another on disc 400. The number of channel pathways included on a given disc 400 may depend, at least in part, on the number of assays to be run on disc 400 or the intended use of disc 400. In some aspects, a different sample may be tested in each pathway, and increasing the number of pathways may increase the number of samples that may be assayed by the same microfluidic disc, e.g., simultaneously or substantially simultaneously. In some aspects, the disc 400 may include an array chamber, e.g., in place of separation chamber 408 and detection chamber 410 as discussed above in connection to FIG. 1.

As shown in FIG. 4, one of the channel pathways of disc 400 includes a waste chamber 420′ that has a different size and shape than the other waste chambers 420. Including a channel pathway with one or more differently sized and/or shaped chambers or channels may, like the markers described herein, signal to a detector or an operator which channel pathway is the first channel pathway. Although disc 400 illustrates an example with a unique feature, i.e., waste chamber 420′, useful in identifying particular channel pathways, disc 400 may not include such a feature. For example, each channel pathway of disc 400 may be identical to the other channel pathways.

In some aspects, the microfluidic disc may include a magnetic stirrer to promote mixing of sample and reagents. For example, any of discs 100, 200, 300, and/or 400 may include relatively small particles, e.g., microbeads or rods, pre-loaded within a mixing chamber. The particles may comprise a ferromagnetic material. A magnet may be positioned under a portion of the disc, and as the disc rotated, a magnetic field in any given mixing chamber may be created and then turned off as that mixing chamber passes over the magnet. This intermittent magnetic field may cause the particles within the mixing chamber to move, which may agitate the contents of the mixing chamber, promoting mixing. The particles may move faster or slower within the mixing chamber depending on the speed at which the disc is rotated. Such particles may be included in other chambers, for example, reaction chambers, sample preparation chambers, or component chambers.

Exemplary discs described herein may include channel pathway components, including chambers, channels, valves, inlets, filters, vents, etc., that may have any suitable size, shape, orientation, arrangement, length, width, depth, or other characteristic. The characteristics chosen for a given disc may depend on, e.g., the type of disc, type of arrays, arrangement of components, disc materials, number of channel pathways, volume or type of testing sample to be used, or any suitable factors or combinations of factors.

Disc Fabrication

Aspects of the disclosure may also be drawn to methods of manufacturing microfluidic discs. Exemplary discs 100, 200, 300, and/or 400 may be fabricated as follows:

(1) A top design of the disc may be laser cut into cast acrylic (or other suitable material) to form one or more inlets and/or one or more vent holes. Alignment holes may also be laser cut into an outward edge of the disc, at a location away from the disc center. The top design may be a substantially flat, disc-shaped surface including one or more holes (e.g., inlets or vent holes). In some aspects, the top design may include no pathway circuitry (e.g., chambers or channels).

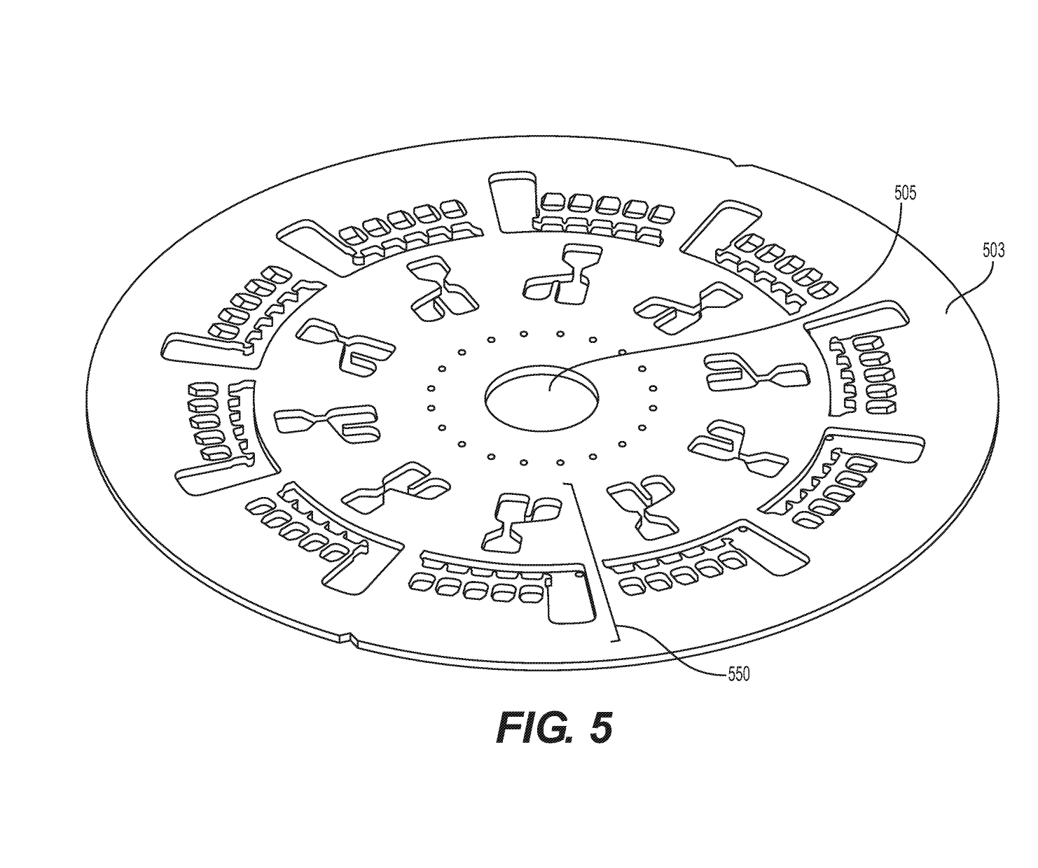

(2) A bottom design of the disc may be laser cut to form one or more alignment holes. The bottom design may be laser cut into a transparent material, such as cast transparent acrylic or other suitable materials. The bottom design may include the footprint of one or more chambers (as shown in FIG. 5) and/or may include one or more valves, filters, and/or channels incorporated into the bottom design.

(3) Window regions may be laser marked on a protective paper layer on the bottom disc design.

(4) A middle layer design containing channels and chambers (whichever are not incorporated into the bottom design, if any) may be cut using vinyl cutter in adhesive.

(5) The disc may then be assembled as follows:

(5a) The protective paper on the bottom disc design may be removed, leaving behind the window regions. An opaque coating (e.g., black, matte paint) may be sprayed on or otherwise applied to the bottom disc design, and then the protective paper covering the window regions that had been left behind may be removed.

(5b) Unwanted (channel, center hole, alignment holes) regions on the adhesive may be peeled/weeded away, but the backing release liner may be left intact.

(5c) Any protective layers remaining on the bottom disc may be cleaned off with suitable solvents and dried.

(5d) The adhesive layer may be carefully aligned with the acrylic using alignment pins, and the bottom release liner may be removed at one region, e.g., a corner. The adhesive may then be contacted with the bottom disc. The alignment pins may be removed, and the bottom release liner of the adhesive may be slowly removed while rolling out the exposed adhesive regions to bond with the bottom design of the disc.

(5e) Steps 5c and 5d may be repeated for the top disc.

(5f) In a thermal lamination step, a thermal laminator may be heated to about 160 degrees Celsius, and the disc may be laminated by passing it through the double rollers of the thermal laminator in either direction. The disc may be passed through the double rollers multiple times, e.g., five or more times. If passed through multiple times, the disc may be rotated after each pass-through to promote uniform lamination.

FIG. 5 shows a bottom portion 503 of a disc, before the bottom portion 503 is sealed with upper lamination. The bottom portion 503 includes a central aperture 505, and a plurality of fluid channel pathways 550, each comprising the footprints of chambers and channel pathways.

In some aspects, fabrication of exemplary discs may not include the middle layer. Instead, the channels, chambers, valves, and/or filters may be incorporated into the bottom design, and the top design may be attached to the bottom design. For example, the bottom design may be directly sealed with the top design. The top design may be formed of the same material or a different material compared to the bottom design. In some aspects, the top design may include minimal or no features (e.g., chambers, channels, etc.). In other aspects, an intermediate bi-adhesive layer may be sandwiched between the top design and the bottom design to seal them together.

In any of the fabrication processes, the bottom designs may be milled, cut, etched, embossed, formed by injection molding, or formed using any suitable additive or subtractive manufacturing technique. When microarrays are used, capture molecules may be attached (e.g., covalently or non-covalently bonded or linked) to the bottom design or other portion of the disc (e.g., in an array chamber) prior to final assembly of the disc during fabrication.

One or more reagents, coatings, density media, capture molecules, fluids, microbeads, etc., (collectively, disc components) may be added to the disc during the fabrication process such that they are pre-loaded into the disc for performing an assay. The component(s) may be in liquid or solid form, or a combination of both. In one aspect, the bottom design of the disc may be formed and then used as a reservoir for the disc components. For example, chambers may be designed into the bottom design of the disc, and then the component(s) may be added to their respective chambers. In some aspects, once loaded with component(s), the chambers (or entire disc) may then be exposed to a lyophilization process to preserve the component(s) in a lyophilized state in order to extend the shelf-life of the component(s) within the disc. After the lyophilization step, additional liquid or solid component(s) may be added to the chambers of the disc. The chambers (or entire disc) may then be exposed again to a lyophilization step to preserve the additional component(s). The component-adding and lyophilization steps may be repeated any suitable number of times. In some aspects, certain component(s) may require lyophilization while other component(s) do not. In such aspects, some of the component(s) may be loaded into the chambers, the lyophilization step may occur, and then additional component(s) may be loaded into the same or different chambers, after which no additional lyophilization step may occur. Or, in other aspects, the lyophilization step may be completely omitted from the fabrication process. Once the components have been added, the top design of the disc may be sealed onto the bottom design, sealing the components into the disc.

In some exemplary aspects, components (e.g., reagent(s), including density media) may be introduced into the chambers in a liquid form and may be sealed within the chambers and/or channels to reduce the likelihood of evaporation of the liquid components or migration of the liquid components on the disc during storage. Exemplary materials suitable for sealing the chambers and/or channels may include, but is not limited to, paraffin and other chemically inert materials. For example, a thin film, such as a paraffin sheet, may be used to seal the liquid components in the chambers before sealing the top disc design over the bottom disc design. The paraffin sheet may seal individual chambers and/or channels, or may comprise a layer of paraffin extending over portions of the disc or over a surface of the disc that defines the chambers and/or channels. In some aspects, paraffin may be incorporated within a valve, e.g., a burst valve, to seal the valve. Sealing the valve may seal the adjacent chamber(s) or channel(s). The paraffin may have a melting temperature below the operating range of the assay and above the storing temperature for the disc. As a result, the paraffin may remain in a solid state, sealing the liquid in the chamber(s), until the disc is introduced into an instrument for operating the disc or until the disc is in use. At that time, the paraffin may melt, allowing the flow of liquids and gases within the channel pathways of the disc.

In other exemplary aspects, liquid components may be stored into rupturable containers, e.g., one or more pouches or a blister packets, which may be ruptured with an automated or manual mechanism to release the liquid components into the channel pathways before or during the operation of the disc. The containers may be ruptured, for example, by a sharp or blunt needle or similar device, by compression, by the application of heat, or in response to centrifugal force generated by rotation of the disc above a certain speed.

In other aspects, the discs may be formed with a loading hole over or near a chamber to be filled. For example, the top design of the disc may include one or more loading holes positioned so that when the top design is sealed over the bottom design, the loading holes align with chambers formed in the bottom design. Loading holes may be aligned with one or more of a reaction chamber, incubation chamber, inlet chamber, component chamber, or separation chamber, for example. After the top design is sealed on the bottom design, one or more disc components may be loaded onto the disc by passing the components through the loading holes and into the chambers aligned with the loading holes. After the components have been introduced into the chambers through the loading holes, may be left open, or, alternatively, may be sealed with a suitable material, sealing the components within the disc. Exemplary loading holes 114, 437 are shown in discs 100 and 400, although in other aspects, discs 100 and 400 may not include loading holes and may be fabricated according to any suitable methods.

In addition to a disc, microfluidic systems according to the present disclosure may also include a detection component for detecting an analyte or target (e.g., biomarker) bound to microbeads via capture molecules as discussed above. FIG. 6 shows an exemplary microfluidic device (alternatively described as a microfluidic system) comprising a microfluidic disc 700, a power source such as a motor 750, and a detection component 760. The disc 700 may include any of the features of discs 100, 200, 300 and/or 400 discussed above, including, e.g., a plurality of channel pathways 703 and a central aperture 705. The channel pathways 703 may be in communication with a plurality of detection chambers, labeled sequentially A-P, as shown. The disc may be operably coupled to the motor 750 via a shaft 740, such that the motor 750 may power rotation of the disc 700 via the shaft 740, and determine the speed and direction of rotation. The motor may control rotation of the disc 700 counterclockwise (in the direction of the arrow shown in FIG. 6) and/or clockwise at a predetermined speed or series of predetermined speeds.

The detection component 760 may be configured to detect the presence of targets by measuring signals from detection molecules bound to the targets and collected in respective detection chambers A-P at or proximate the edge of the disc 700. For example, the detection component 760 may detect absorbance, fluorescence, chemiluminescence, or electrochemiluminscence, or any other type of signals from a detectable label of the disc 700. The amount of a target in each detection chamber A-P (and thus the concentration of the target in the original sample) may be determined based on the signal detected, the location of each detection chamber A-P relative to the others, and the rotation characteristics of the disc 700. For example, if the collection of signal begins when the detection component 760 is aligned with detection chamber A, as the disc 700 rotates, the amount of signal emitted from detection chamber A may be distinguished from the amount of signal emitted from detection chambers B-P based on the speed of rotation and the location of detection chamber A. Thus, for each full rotation of the disc 700, the detection component 760 may collect signal for each of detection chambers A-P. When the detection chambers A-P contain different targets (e.g., due to the use of different capture molecules to bind to the targets as discussed above), the concentrations of multiple targets present in the sample may be determined simultaneously or substantially simultaneously.

In some aspects, the detection component 760 may be an optical detector including a light source 765 for generating light, a detector 767, and optics 762 (e.g., mirrors and/or lenses) directing light from the light source 765 to the disc 700 and redirecting light emitted from the disc 700 to the detector 767. In at least one embodiment, the detection component comprises light excitation at various wavelengths in the visible region and also outside the visible region, including, but not limited to a laser excitation, or a LED excitation and a complementary metal-oxide-semiconductor (CMOS) sensor for detection of specific wavelengths, with the use of one or more appropriate filters and/or dichroic beam-splitters.

The detection component 760 may further include a reader for analyzing data from the detector 767 and a screen for displaying output from the reader. The reader may be optical. In some embodiments, the detection component 760 may include an imaging system, e.g., comprising a charge coupled device (CCD) camera. Output from the imaging system may be displayed on a computer screen or other user interface or viewing apparatus, including, but not limited to, e.g., a liquid crystal display (LCD) device. In some aspects, output from the imaging system may be transferred to a remote user interface such as a tablet computer or other computer controlled device such as a laptop or smartphone. The data may be transferred via wire or wireless communication, including, but not limited to, Bluetooth, and/or may be stored or archived on remote servers, e.g., in the Internet cloud.

FIG. 7 shows an exemplary housing 800 of a device according to some aspects of the present disclosure. For example, the housing may contain the device of FIG. 6. In some aspects, the housing 800 may include a cover 816 (e.g., movable via hinges as shown or other suitable mechanism) and a door 820 that may be opened and closed for inserting and removing a microfluidic disc. The housing may contain additional components of the device, such as heating elements and/or magnets configured to align with particular chambers or portions of the disc, as discussed above.

Analyzing a sample according to the present disclosure may include determining a value or a set of values associated with a given sample by one or more quantitative and/or qualitative measurements. For example, “analyzing” according to some embodiments of the present disclosure includes measuring constituent expression levels in a sample obtained from a subject and comparing the levels against constituent levels in a sample or set of samples from the same subject (e.g., the samples being collected at different times to assess the progression of a potential health condition) or other subject(s) (e.g., for comparison to a confirmed medical diagnosis of disease or lack of disease in another subject). The data obtained according to the present disclosure may include the presence or absence of specific biomarker or biomarkers in the sample or the presence or absence of the plurality of biomarkers in the sample. In some embodiments, the data may include the concentration of a plurality of biomarkers in a sample, and their relative presence compared to a physiological level, e.g., to determine over-expression, normal-expression, or under-expression of a plurality of biomarkers.

In at least one embodiment, scoring the sample comprises analyzing the data and outputting a score. A “score” may include, but is not limited to, a value or set of values that may be selected and/or used for analytic, comparison, diagnostic, and/or other purposes according to the present disclosure. In some embodiments, for example, a score may be used to assess a subject's health condition or medical condition based on, e.g., a measured amount of one or more constituents (e.g., targets, such as biomarkers) of a sample obtained from the subject.

Analysis of the data can include use of a predictive model. A “predictive model” may include, but is not limited to, a mathematical construct developed using an algorithm or combination of algorithms for grouping sets of data, e.g., to allow for discrimination of the grouped data. A predictive model according to the present disclosure may be developed using any suitable mathematical and/or statistical methods including, but not limited to, principal component analysis (PCA) and/or linear discriminant analysis (LDA). In some examples, the grouped data includes data for each biomarker of a panel of biomarkers.

PCA is a technique that may be used to reduce multidimensional data sets to lower dimensions for analysis. Mathematically, PCA may be defined as an orthogonal linear transformation that transforms data to a new coordinate system, such that the greatest variance by any projection of the data comes to lie on the first coordinate (called the first principal component), the second greatest variance on the second coordinate, and so on. PCA may be used as a tool in exploratory data analysis and for making predictive models. PCA also may include calculation of the eigenvalue decomposition of a data covariance matrix or singular value decomposition of a data matrix, e.g., after mean centering the data for each attribute. The results of a PCA may be discussed in terms of component scores and loadings.

LDA is a method that may be used to find the linear combination of features that best separates two or more classes of objects or events. The resulting combination may be used as a linear classifier, or, alternatively, for dimensionality reduction before later classification.

The present disclosure includes a method for scoring a sample from a subject, the method comprising, e.g., categorizing a human sample using quantitative data associated with a plurality of biomarkers, wherein the biomarkers are associated with a particular disease or other health condition, e.g., breast cancer. For example, the method of categorizing the sample may use data associated with a plurality of biomarkers associated with breast cancer. In some aspects, the plurality of biomarkers associated with breast cancer includes at least CA 15-3 and OPN. Additional biomarkers may include, e.g., Her-2, MMP-2, VEGF, p53, CA 125, CEA, and/or SER. For example, the plurality of biomarkers may include CA 15-3, OPN, Her-2 and MMP-2, or CA 15-3, OPN, Her-2, p53, CA 125, CEA, and SER. In at least one embodiment, the method of categorizing a sample uses data associated with the following biomarkers: CA 15-3, OPN, Her-2, and MMP-2.

In some exemplary discs of the present disclosure, a single analyte may be tested (e.g., a single biomarker captured and detected as part of a biomarker assay or panel) in each channel pathway, and each reaction chamber of a channel pathway may contain the same reagent or combination of reagents. In some examples, multiple biomarkers may be measured in each channel pathway of a microfluidic disc, and different reagents or combinations of reagents may be contained in each reaction chamber in that channel pathway. For example, a detection reagent may have a specific fluorescent tag, and by measuring the intensity of each of the specific tags at different wavelengths per each channel, multiple biomarkers may be measured per channel.

Analysis according to some methods of the present disclosure may include categorizing a sample (e.g., categorizing the levels of biomarkers of a sample according to a biomarker panel) into categories according to a score produced with the predictive model. Overexpression of biomarkers may generally be understood as a sign of disease. Based on the amount of overexpression, an appropriate score and category may be assigned. Disease categories and corresponding biomarker levels have been reported. See, for example, U.S. Application Publication No. 2008/0200342 A1, incorporated by reference herein. Categories may include, for example, a healthy categorization (e.g., disease-free), an early-stage disease categorization, and a late-stage disease categorization. For example, the categorization may be chosen from a healthy categorization, an early-stage disease categorization, or a late-stage disease categorization.

Diagnostic information obtained according to the present disclosure may be compared to reference data of biomarker levels measured for patients with a confirmed diagnosis of the same disease or health collection. The probability that the diagnosis is correct may be calculated, e.g., as a linear regression of the data to compute specificity and sensitivity of the panel. The probability that categorization is correct may be model-dependent and/or biomarker-dependent, and can be at least 60%, at least 70%, at least 80%, at least 87%, at least 90%, or at least 95% correct. In some embodiments, a probability that the categorization is correct may be at least 60%, at least 70%, at least 80%, at least 87%, at least 90%, or at least 95%. In one example, a single biomarker for the screening of patients with breast cancer may provide a predictive value less than 70%, whereas a panel of biomarkers tested simultaneously may provide a combined effect to increase the predictive value to greater than 90%, e.g., a predictive value of 91%.

As mentioned above, as a disease or other health condition evolves or progresses over time, some or all biomarkers of a biomarker panel may be overexpressed, and continue to be overexpressed. Thus, measuring the biomarkers at different times (e.g., over months and/or years, according to the stage or aggressiveness of the disease) may provide information regarding disease progression in the subject. For example, biomarker levels may be measured every 1, 2, 3, or 4 weeks, every 1, 2, 3, 4, 5, 6, 7, 8, 9, 10, 11, or 12 months, or every 1, 2, 3, 4 or 5 years. For each set of measurements of a biomarker panel, a score may be determined as discussed above. In some aspects, a first score (e.g., based on the measured levels of biomarkers in a biomarker panel at a first time) for a first sample obtained from a subject may be compared to a second score (e.g., based on the measured levels for the same biomarker panel at a second, later time) determined for a second sample obtained from the subject. This comparison also may be used e.g., to determine the progress or effectiveness of therapy for the treatment of disease. A difference between the first score and the second score may indicate a disease stage, such as a disease stage of breast cancer. In some embodiments, the score may be used to diagnose a neoplastic breast disease, such as breast cancer.

The following examples are intended to illustrate the present disclosure without, however, being limiting in nature. It is understood that the present disclosure encompasses additional embodiments consistent with the foregoing description and following examples.

### EXAMPLES

### Example 1

A multiplex assay for a panel of 5 biomarkers of breast cancer is performed using the microfluidic disc shown in FIG. 4 as follows:

(1) Whole blood sample is obtained from a subject from a finger prick or venipuncture.

(2) A drop of the blood is introduced in each sample inlet chamber of the disc via a metered disposable transfer pipette.

(3) The disc is placed into a microfluidic device that contains a motor as a power source and an optical detector, and the cover of the device is closed. The disc is positioned such that it is coupled to the motor (which controls the direction and speed of rotation of the disc) and positioned above the detector, the detector being located towards the periphery of the disc. The device includes a program for running a breast cancer screening assay by rotation of the disc at a series of predetermined speeds as described in steps (4)-(11) below. The assay program is activated.

(4) The disc is spun at 1000 revolutions per minute (RPM) to transfer each sample aliquot from the inlet chamber to the sedimentation chamber.

(5) The disc is then spun at 3000 RPM to separate blood cells from plasma in the blood, such that the blood cells remain in the sedimentation chamber while the plasma enters the plasma chamber.

(6) The disc is then spun at 250 RPM to siphon the plasma from the plasma chamber into individual metering chambers (5 μL of plasma into each metering chamber) in communication with the plasma chamber.

(7) The disc is then spun at 750 RPM to eliminate extra plasma into the waste chamber in communication with the metering chambers.

(8) The disc is then spun at 1000 RPM to move the plasma from the metering chambers to respective reaction/incubation chambers in communication with the metering chambers. Each reaction/incubation chamber contains reagents (capture antibodies attached to microbeads, detection antibodies, and any additives such as salts and/or buffers to control pH) specific to one of the biomarkers of the panel for assaying the biomarker. The reagents include the microbeads (attached to the capture molecules) suspended in liquid, gel, or lyophilized material(s). A single biomarker is tested in each channel pathway, and each reaction chamber of a channel pathway contains the same reagent or combination of reagents.

(9) The disc is spun at 300 RPM in a single direction (clockwise or counterclockwise) or in alternating clockwise and counterclockwise directions, to improve reconstitution of reagents and the kinetics of reaction between the biomarkers and the reagents.

(10) The disc is then spun at 2000 RPM to move the incubated sample into separation chambers in communication with the respective reaction/incubation chambers, where the biomarkers bound to microbeads form pellets within respective detection chambers at the periphery of the disc.

(11) While the disc is kept spinning at 2000 RPM, detection of the biomarkers of the pellets is performed by the optical detector positioned under the plane of the disc in proximity of the detection chambers.

(12) The raw signal (fluorescence, luminescence, and/or absorption) is recorded, amplified and analyzed. The signal is recorded and is correlated to each biomarker to determine the concentration of each biomarker in the original blood sample.

It is intended that the specification and examples be considered as exemplary only, with a true scope and spirit of the present disclosure being indicated by the following claims.

What is claimed is:

1. A microfluidic device, comprising:
a disc comprising at least one microfluidic channel pathway extending radially outward from a center of the disc, wherein the at least one channel pathway comprises:
an inlet for receiving a sample;
a first chamber fluidly connected to the inlet;
a second chamber fluidly connected to the first chamber, wherein the second chamber is positioned radially inward relative to the first chamber;
at least one third chamber fluidly connected to the second chamber via an outlet channel, the at least one third chamber being positioned radially outward of the second chamber; and
at least one fourth chamber fluidly connected to the at least one third chamber and positioned radially outward of the at least one third chamber;
wherein at least one of the first, second, third, or fourth chambers contains at least one reagent pre-loaded into the disc.

2. The device of claim 1, wherein the fluid connection between the first chamber and the second chamber has a width that is narrower than a width of either the first chamber or the second chamber.

3. The device of claim 2, wherein the second chamber is fluidly connected to a compression chamber positioned at a same or similar radial position relative to the second chamber.

4. The device of claim 1, wherein the outlet channel between the second chamber and the at least one third chamber is curved and includes a radially inward curve and a radially outward curve.

5. The device of claim 1, wherein the at least one channel pathway comprises a main channel joining the outlet channel to the at least one third chamber, the main channel extending in a direction transverse to a radial direction of the disc.

6. The device of claim 5, wherein the main channel is in communication with an overflow channel for receiving fluid in excess of fluid entering the at least one third chamber.

7. The device of claim 1, wherein the fluid connection between the at least one third chamber and the at least one fourth chamber includes a first valve.

8. The device of claim 1, wherein the at least one channel pathway further comprises at least one fifth chamber fluidly connected to the at least one fourth chamber and positioned radially outward of the at least one fourth chamber, the fluid connection between the fourth and fifth chambers including a second valve.

9. The device of claim 8, wherein the first valve is configured to open in response to a first threshold of force, and the second valve is configured to open in response to a second threshold of force, wherein the second threshold of force is greater than the first threshold of force.

10. The device of claim 1, wherein an end of the at least one microfluidic channel, proximate an edge of the disc, is tapered.

11. The device of claim 10, further comprising at least one sixth chamber fluidly connected to the at least one fourth chamber, wherein an end of the at least one sixth chamber defines the end of the at least one microfluidic channel.

12. The device of claim 1, wherein the at least one reagent pre-loaded into the disc comprises a plurality of molecules attached to microbeads or a plurality of molecules attached to a portion of the disc.

13. The device of claim 12, wherein each molecule of the plurality of molecules is configured to capture an analyte chosen from an oligonucleotide, a protein, or a small molecule.

14. The device of claim 1, wherein the at least one reagent pre-loaded into the disc comprises a density medium.

15. The device of claim 1, wherein the at least one fourth chamber comprises a plurality of fourth chambers in parallel.

16. The device of claim 15, wherein each fourth chamber is in fluid communication with a respective fifth chamber and a respective sixth chamber.

17. The device of claim 1, wherein the disc comprises a plurality of channel pathways, each channel pathway extending radially outward from the center of the disc, and wherein the center of the disc includes an aperture.

18. A microfluidic device, comprising:
a disc comprising at least one microfluidic channel pathway extending radially outward from a center of the disc, wherein the at least one channel pathway comprises:
an inlet for receiving a sample;
a first chamber fluidly connected to the inlet;
a second chamber fluidly connected to the first chamber, wherein the second chamber is positioned radially inward relative to the first chamber;
an outlet channel fluidly connected to the second chamber and extending from the second chamber to a main channel located radially outward of the second chamber;
a plurality of third chambers fluidly connected to the main channel;
a plurality of fourth chambers, each fourth chamber being fluidly connected to, and positioned radially outward of, a respective third chamber; and
a plurality of fifth chambers, each fifth chamber being fluidly connected to, and positioned radially outward of, a respective fourth chamber;
wherein at least one of the first, second, third, fourth, or fifth chambers contains at least one reagent pre-loaded into the disc.

19. The device of claim 18, wherein each fifth chamber of the plurality of fifth chambers contains a density medium.

20. The device of claim 18, wherein the second chamber is fluidly connected to a compression chamber positioned at a same or similar radial position relative to the second chamber.
